(19) United States
(12) Patent Application Publication
(10) Pub. No.: US 2025/0080183 A1
(43) Pub. Date: Mar. 6, 2025

(54) ENERGY DETECTION THRESHOLD ADJUSTMENT BASED ON SENSING AND TRANSMISSION BEAMS

(71) Applicant: QUALCOMM Incorporated, San Diego, CA (US)

(72) Inventors: Giovanni CHISCI, San Diego, CA (US); Jing SUN, San Diego, CA (US); Vinay CHANDE, San Diego, CA (US); Arumugam CHENDAMARAI KANNAN, San Diego, CA (US); Siyi CHEN, Beijing (CN); Xiaoxia ZHANG, San Diego, CA (US)

(21) Appl. No.: 18/553,838

(22) PCT Filed: May 8, 2021
(86) PCT No.: PCT/CN2021/092337

§ 371 Date: Oct. 3, 2023

(51) Int. Cl. H04B 7/06; H04W 74/0808

(52) U.S. Cl. CPC H04B 7/0617; H04W 74/0808

(57) ABSTRACT

Methods, systems, and devices for wireless communication are described. A communication device may receive control signaling indicating a beam configuration. The communication device may select a first beam (for example, a sensing beam) for wireless communication based on the beam configuration. The first beam including a first beam gain and a first pointing direction. The communication device may select a second beam (for example, a transmitting beam) based on the beam configuration. The second beam including a second beam gain and a second pointing direction. The communication device may determine (for example, adjust) an energy detection threshold (EDT) associated with the second beam based on the second beam gain in the first pointing direction and the first beam gain in the first pointing direction. The communication device may sense a channel using the second beam and the EDT associated with the second beam.

### CROSS REFERENCE

The present Application is a 371 national stage filing of International PCT Application No. PCT/CN2021/092337 by CHISCI et al. entitled “ENERGY DETECTION THRESHOLD ADJUSTMENT BASED ON SENSING AND TRANSMISSION BEAMS,” filed May 8, 2021, which is assigned to the assignee hereof, and which is expressly incorporated by reference in its entirety herein.

### TECHNICAL FIELD

The following relates to wireless communication, including adjusting an energy detection threshold (EDT) for channel sensing operations.

### DESCRIPTION OF THE RELATED TECHNOLOGY

Wireless communications systems are widely deployed to provide various types of communication content such as voice, video, packet data, messaging, broadcast, and so on. These systems may be capable of supporting communication with multiple users by sharing the available system resources (for example, time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems, which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM).

A wireless communications system may include one or more base stations, each simultaneously supporting wireless communication services for multiple communication devices, which may be otherwise known as user equipment (UE). In the wireless communications system, a UE may support beamformed communications over an unlicensed radio frequency spectrum band (which may also be referred to as a shared radio frequency spectrum band). To support beamformed communications (for example, uplink beamformed communications) over the unlicensed radio frequency spectrum band, the UE may sense a wireless channel that may be shared with other communication devices (for example, other UEs) to determine whether the wireless channel is occupied. The UE may be configured to sense the wireless channel according to an energy detection threshold (EDT).

### SUMMARY

The systems, methods and devices of this disclosure each have several innovative aspects, no single one of which is solely responsible for the desirable attributes disclosed herein.

One innovative aspect of the subject matter described in this disclosure can be implemented in a method for wireless communication at a (UE). The method may include receiving control signaling indicating a beam configuration; selecting a first beam for wireless communication based at least in part on the beam configuration, the first beam being associated with a first pointing direction; selecting a second beam based at least in part on the beam configuration, the second beam being associated with a second pointing direction; determining an energy detection threshold (EDT) associated with the second beam based at least in part on a first beam gain of the first beam in the first pointing direction and a second beam gain of the second beam in the first pointing direction; sensing a channel using the second beam based at least in part on the EDT associated with the second beam.

Another innovative aspect of the subject matter described in this disclosure can be implemented in an apparatus for wireless communication at a UE. The apparatus may include a processor, memory coupled with the processor, and instructions stored in the memory. The instructions may be executable by the processor to cause the apparatus to receive control signaling indicating a beam configuration; select a first beam for wireless communication based at least in part on the beam configuration, the first beam being associated with a first pointing direction; select a second beam based at least in part on the beam configuration, the second beam being associated with a second pointing direction; determine an EDT associated with the second beam based at least in part on a first beam gain of the first beam in the first pointing direction and a second beam gain of the second beam in the first pointing direction; sense a channel using the second beam based at least in part on the EDT associated with the second beam.

Another innovative aspect of the subject matter described in this disclosure can be implemented in another apparatus for wireless communication at a UE. The apparatus may include means for receiving control signaling indicating a beam configuration; means for selecting a first beam for wireless communication based at least in part on the beam configuration, the first beam being associated with a first pointing direction; means for selecting a second beam based at least in part on the beam configuration, the second beam being associated with a second pointing direction; means for determining an EDT associated with the second beam based at least in part on a first beam gain of the first beam in the first pointing direction and a second beam gain of the second beam in the first pointing direction; means for sensing a channel using the second beam based at least in part on the EDT associated with the second beam.

Another innovative aspect of the subject matter described in this disclosure can be implemented in a non-transitory computer-readable medium storing code for wireless communication at a UE. The code may include instructions executable by a processor to receive control signaling indicating a beam configuration; select a first beam for wireless communication based at least in part on the beam configuration, the first beam being associated with a first pointing direction; select a second beam based at least in part on the beam configuration, the second beam being associated with a second pointing direction; determine an EDT associated with the second beam based at least in part on a first beam gain of the first beam in the first pointing direction and a second beam gain of the second beam in the first pointing direction; sense a channel using the second beam based at least in part on the EDT associated with the second beam.

Another innovative aspect of the subject matter described in this disclosure can be implemented in a method for wireless communication at a UE. The method may include receiving control signaling indicating a beam configuration; selecting a first beam for wireless communication based at least in part on the beam configuration, the first beam being associated with a first pointing direction; selecting a second beam based at least in part on the beam configuration, the second beam being associated with a second pointing direction; determining an EDT associated with the second beam based at least in part on a second beam gain of the second beam in the second pointing direction and a first beam gain of the first beam in the first pointing direction; and sensing a channel using the second beam based at least in part on the EDT associated with the second beam.

Another innovative aspect of the subject matter described in this disclosure can be implemented in an apparatus for wireless communication at a UE. The apparatus may include a processor, memory coupled with the processor, and instructions stored in the memory. The instructions may be executable by the processor to cause the apparatus to receive control signaling indicating a beam configuration; select a first beam for wireless communication based at least in part on the beam configuration, the first beam being associated with a first pointing direction; select a second beam based at least in part on the beam configuration, the second beam being associated with a second pointing direction; determine an EDT associated with the second beam based at least in part on a second beam gain of the second beam in the second pointing direction and a first beam gain of the first beam in the first pointing direction; and sense a channel using the second beam based at least in part on the EDT associated with the second beam.

Another innovative aspect of the subject matter described in this disclosure can be implemented in another apparatus for wireless communication at a UE. The apparatus may include means for receiving control signaling indicating a beam configuration; means for selecting a first beam for wireless communication based at least in part on the beam configuration, the first beam being associated with a first pointing direction; means for selecting a second beam based at least in part on the beam configuration, the second beam being associated with a second pointing direction; means for determining an EDT associated with the second beam based at least in part on a second beam gain of the second beam in the second pointing direction and a first beam gain of the first beam in the first pointing direction; and means for sensing a channel using the second beam based at least in part on the EDT associated with the second beam.

Another innovative aspect of the subject matter described in this disclosure can be implemented in a non-transitory computer-readable medium storing code for wireless communication at a UE. The code may include instructions executable by a processor to receive control signaling indicating a beam configuration; select a first beam for wireless communication based at least in part on the beam configuration, the first beam being associated with a first pointing direction; select a second beam based at least in part on the beam configuration, the second beam being associated with a second pointing direction; determine an EDT associated with the second beam based at least in part on a first beam gain of the first beam in the first pointing direction and a second beam gain of the second beam in the first pointing direction; sense a channel using the second beam based at least in part on the EDT associated with the second beam.

### BRIEF DESCRIPTION OF THE DRAWINGS

FIGS. 1 and 2 illustrate examples of wireless communications systems that support energy detection threshold (EDT) adjustment based on sensing and transmission beams in accordance with aspects of the present disclosure.

FIG. 3 illustrates an example of a beam configuration that supports EDT adjustment based on sensing and transmission beams in accordance with aspects of the present disclosure.

FIGS. 4A and 4B illustrate examples of beam configurations that support EDT adjustment based on sensing and transmission beams in accordance with aspects of the present disclosure.

FIG. 5 illustrates an example of a beam configuration that supports EDT adjustment based on sensing and transmission beams in accordance with aspects of the present disclosure.

FIGS. 6A-6C illustrate examples of beam configurations that support EDT adjustment based on sensing and transmission beams in accordance with aspects of the present disclosure.

FIGS. 7A-7C illustrate examples of beam configurations that support EDT adjustment based on sensing and transmission beams in accordance with aspects of the present disclosure.

FIG. 8 illustrates an example of a beam configuration that supports EDT adjustment based on sensing and transmission beams in accordance with aspects of the present disclosure.

FIG. 9 illustrates an example of a method that supports EDT adjustment based on sensing and transmission beams in accordance with aspects of the present disclosure.

FIGS. 10 and 11 show block diagrams of devices that support EDT adjustment based on sensing and transmission beams in accordance with aspects of the present disclosure.

FIG. 12 shows a block diagram of a communications manager that supports EDT adjustment based on sensing and transmission beams in accordance with aspects of the present disclosure.

FIG. 13 shows a diagram of a system including a device that supports EDT adjustment based on sensing and transmission beams in accordance with aspects of the present disclosure.

FIGS. 14 and 15 show flowcharts illustrating methods that support EDT adjustment based on sensing and transmission beams in accordance with aspects of the present disclosure.

### DETAILED DESCRIPTION

A wireless communications system may include various communication devices, which may be configured with multiple antennas for beamformed communications. The communication devices may operate in an unlicensed radio frequency spectrum band, which may be shared between the communication devices for the beamformed communications. To support the beamformed communications over the unlicensed radio frequency spectrum band, the communication devices may sense a wireless channel to determine whether the wireless channel is idle (in other words, unoccupied). For example, the communication devices may perform a contention procedure, such as a listen-before-talk procedure. As part of the listen-before-talk procedure, the communication devices may sense a channel using a sensing beam and may transmit beamformed communications using a transmitting beam in response to sensing the channel as idle. The communication devices may determine whether the wireless channel is idle based on an energy detection threshold (EDT), which may be used to detect other transmissions on the wireless channel. For example, if a communication device wants to transmit, the communication device may detect an energy level on the wireless channel. If the energy level in the wireless channel is below the EDT threshold, then the communication device may perform beamformed communications. In some cases, there may be a mismatch between a sensing beam and a transmitting beam, however, which may impact the reliability of the beamformed communications in response to sensing an idle wireless channel. It is desirable to improve sensing of the wireless channel in cases that there is a mismatch between a sensing beam and a transmitting beam.

Various aspects generally relate to adjusting, by a wireless communication device, an EDT for mismatched beams, such as for a mismatch between a transmit beam and a sensing beam. In one aspect of the present disclosure, the communication device may adjust an EDT based on a difference between a respective beam gain of a sensing beam in a pointing direction of a transmit beam and a respective beam gain of the transmit beam in the pointing direction of the transmit beam. In another aspect of the present disclosure, the communication device may adjust an EDT based on a difference between a respective beam gain of a sensing beam in a pointing direction of the sensing beam and a respective beam gain of a transmit beam in a pointing direction of the transmit beam. Either of these aspects can result in the pointing directions of the sensing beam and the transmit beam occurring within a threshold. The communication device may then sense a channel using the sensing beam based on the adjusted EDT associated with the sensing beam. For example, the communication device may analyze (for example, test) the sensed energy of the channel against the adjusted EDT.

Particular aspects of the subject matter described in this disclosure may be implemented to realize one or more of the following potential advantages. The techniques employed by the described communication devices may provide benefits and enhancements to the operation of the communication devices, including reduced power consumption, and may promote higher reliability and lower latency wireless communication services, among other benefits. For example, a communication device may increase battery life by efficiently sensing a wireless channel according to an adjusted EDT that accounts for a mismatch between a sensing beam and a transmitting beam used for beamformed communications. The adjusted EDT may extend a sensing coverage for the wireless channel such that the determination of whether the wireless channel is idle covers both the sensing beam direction and the transmitting beam direction. Additionally, a communication device may promote higher reliability beamformed communications by sensing a wireless channel according to an adjusted EDT. The adjusted EDT may extend the sensing coverage of the wireless channel, which may reduce the likelihood that the wireless channel is idle in a direction of the sensing beam and busy in a direction of the transmitting beam, which may mitigate interference for the beamformed communications.

Aspects of the disclosure are initially described in the context of wireless communications systems. Aspects of the disclosure are further illustrated by and described with reference to apparatus diagrams, system diagrams, and flowcharts that relate to EDT adjustment based on sensing and transmission beams.

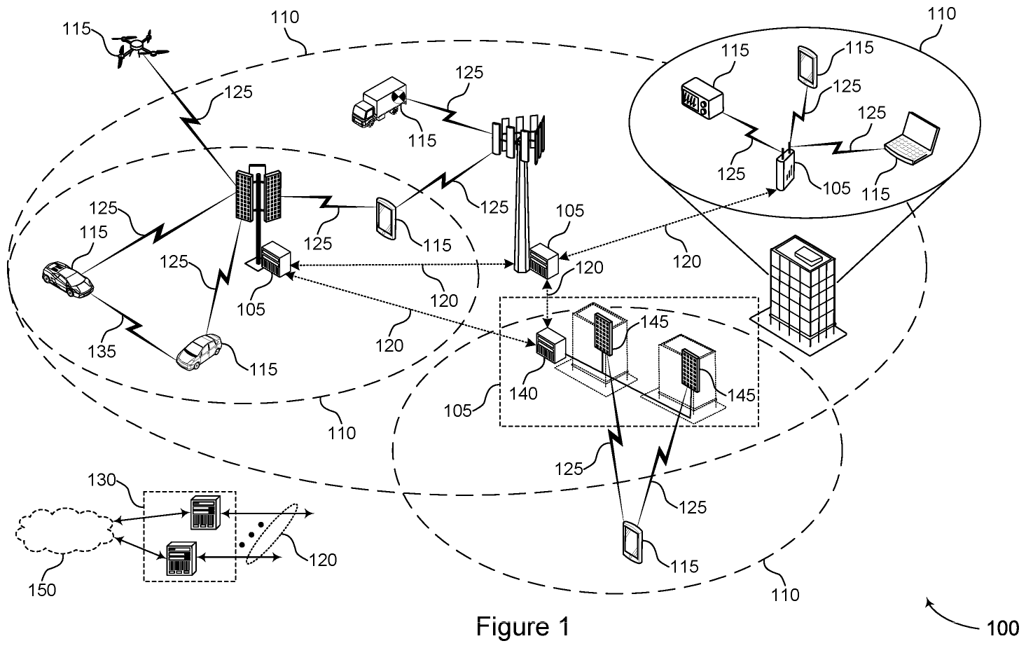

FIG. 1 illustrates an example of a wireless communications system 100 that supports EDT adjustment based on sensing and transmission beams in accordance with aspects of the present disclosure. The wireless communications system 100 may include one or more base stations 105, one or more UEs 115, and a core network 130. In some examples, the wireless communications system 100 may be an LTE network, an LTE-A network, an LTE-A Pro network, or a NR network. In some examples, the wireless communications system 100 may support enhanced broadband communications, ultra-reliable (for example, mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 that the UEs 115 and the base station 105 may establish one or more communication links 125. The coverage area 110 may be an example of a geographic area that a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (for example, core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (for example, via an S1, N2, N3, or other interface). The base stations 105 may communicate with one another over the backhaul links 120 (for example, via an X2, Xn, or other interface) either directly (for example, directly between base stations 105), or indirectly (for example, via core network 130), or both. In some examples, the backhaul links 120 may be or include one or more wireless links. One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, in which the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples. The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (for example, a bandwidth part (BWP)) that is operated according to one or more physical layer channels for a given radio access technology (for example, LTE, LTE-A, LTE-A Pro, NR). Each physical layer channel may carry acquisition signaling (for example, synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (for example, in a carrier aggregation configuration), a carrier may also have acquisition signaling or control signaling that coordinates operations for other carriers. A carrier may be associated with a frequency channel (for example, an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode in which initial acquisition and connection may be conducted by the UEs 115 via the carrier, or the carrier may be operated in a non-standalone mode in which a connection is anchored using a different carrier (for example, of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (for example, in an FDD mode) or may be configured to carry downlink and uplink communications (for example, in a TDD mode). A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (for example, 1.4, 3, 5, 10, 15, 20, 40, or 80 megahertz (MHz)). Devices of the wireless communications system 100 (for example, the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (for example, a sub-band, a BWP) or all of a carrier bandwidth.

Signal waveforms transmitted over a carrier may be made up of multiple subcarriers (for example, using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol duration (for example, a duration of one modulation symbol) and one subcarrier, in which the symbol duration and subcarrier spacing are inversely related. The number of bits carried by each resource element may depend on the modulation scheme (for example, the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (for example, spatial layers or beams), and the use of multiple spatial layers may further increase the data rate or data integrity for communications with a UE 115.

One or more numerologies for a carrier may be supported, in which a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs. The time intervals for the base stations 105 or the UEs 115 may be expressed in multiples of a basic time unit, which may, for example, refer to a sampling duration of Tₛ=1/(Δfₘₐₓ·N_{f}) seconds, in which Δfₘₐₓ may represent the maximum supported subcarrier spacing, and N_{f} may represent the maximum supported discrete Fourier transform (DFT) size. Time intervals of a communications resource may be organized according to radio frames each having a specified duration (for example, 10 milliseconds (ms)). Each radio frame may be identified by a system frame number (SFN) (for example, ranging from 0 to 1023).

Each frame may include multiple consecutively numbered subframes or slots, and each subframe or slot may have the same duration. In some examples, a frame may be divided (for example, in the time domain) into subframes, and each subframe may be further divided into a number of slots. Alternatively, each frame may include a variable number of slots, and the number of slots may depend on subcarrier spacing. Each slot may include a number of symbol durations (for example, depending on the length of the cyclic prefix prepended to each symbol duration). In some wireless communications systems 100, a slot may further be divided into multiple mini-slots containing one or more symbols. Excluding the cyclic prefix, each symbol duration may contain one or more (for example, N_{f}) sampling durations. The duration of a symbol duration may depend on the subcarrier spacing or frequency band of operation. A subframe, a slot, a mini-slot, or a symbol may be the smallest scheduling unit (for example, in the time domain) of the wireless communications system 100 and may be referred to as a transmission time interval (TTI). In some examples, the TTI duration (for example, the number of symbol durations in a TTI) may be variable. Additionally or alternatively, the smallest scheduling unit of the wireless communications system 100 may be dynamically selected (for example, in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (for example, a control resource set (CORESET)) for a physical control channel may be defined by a number of symbol durations and may extend across the system bandwidth or a subset of the system bandwidth of the carrier. One or more control regions (for example, CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (for example, control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (for example, over a carrier) and may be associated with an identifier for distinguishing neighboring cells (for example, a physical cell identifier (PCID), a virtual cell identifier (VCID), or others). In some examples, a cell may also refer to a geographic coverage area 110 or a portion of a geographic coverage area 110 (for example, a sector) that the logical communication entity operates. Such cells may range from smaller areas (for example, a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (for example, several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (for example, licensed, unlicensed) frequency bands as macro cells. Small cells may provide unrestricted access to the UEs 115 with service subscriptions with the network provider or may provide restricted access to the UEs 115 having an association with the small cell (for example, the UEs 115 in a closed subscriber group (CSG), the UEs 115 associated with users in a home or office). A base station 105 may support one or multiple cells and may also support communications over the one or more cells using one or multiple component carriers. In some examples, a carrier may support multiple cells, and different cells may be configured according to different protocol types (for example, MTC, narrowband IoT (NB-IoT), enhanced mobile broadband (eMBB)) that may provide access for different types of devices.

A base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

Some UEs 115, such as MTC or IoT devices, may be low cost or low complexity devices and may provide for automated communication between machines (for example, via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (for example, a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode if not engaging in active communications, operating over a limited bandwidth (for example, according to narrowband communications), or a combination of these techniques. For example, some UEs 115 may be configured for operation using a narrowband protocol type that is associated with a defined portion or range (for example, set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (for example, mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (for example, using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

The D2D communication link 135 may be an example of a communication channel, such as a sidelink communication channel, between vehicles (for example, UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (for example, base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (for example, a mobility management entity (MME), an access and mobility management function (AMF)) and at least one user plane entity that routes packets or interconnects to external networks (for example, a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (for example, radio heads and ANCs) or consolidated into a single network device (for example, a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (for example, less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (for example, from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. If operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (for example, LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (for example, the same codeword) or different data streams (for example, different codewords). Different spatial layers may be associated with different antenna ports used for channel measurement and reporting. MIMO techniques include single-user MIMO (SU-MIMO), in which multiple spatial layers are transmitted to the same receiving device, and multiple-user MIMO (MU-MIMO), in which multiple spatial layers are transmitted to multiple devices.

Beamforming, which may also be referred to as spatial filtering, directional transmission, or directional reception, is a signal processing technique that may be used at a transmitting device or a receiving device (for example, a base station 105, a UE 115) to shape or steer an antenna beam (for example, a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (for example, with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (for example, antenna panels) to conduct beamforming operations for directional communications with a UE 115. Some signals (for example, synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (for example, by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (for example, a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (for example, by a base station 105 or a UE 115) may be performed using multiple beam directions, and the device may use a combination of digital precoding or radio frequency beamforming to generate a combined beam for transmission (for example, from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (for example, a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (for example, a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (for example, for identifying a beam direction for subsequent transmission or reception by the UE 115) or for transmitting a signal in a single direction (for example, for transmitting data to a receiving device).

A receiving device (for example, a UE 115) may try multiple receive configurations (for example, directional listening) if receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (for example, different directional listening weight sets) applied to signals received at multiple antenna elements of an antenna array, or by processing received signals according to different receive beamforming weight sets applied to signals received at multiple antenna elements of an antenna array, any of that may be referred to as “listening” according to different receive configurations or receive directions. In some examples, a receiving device may use a single receive configuration to receive along a single beam direction (for example, if receiving a data signal). The single receive configuration may be aligned in a beam direction determined based on listening according to different receive configuration directions (for example, a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (for example, using a cyclic redundancy check (CRC)), forward error correction (FEC), and retransmission (for example, automatic repeat request (ARQ)). HARQ may improve throughput at the MAC layer in poor radio conditions (for example, low signal-to-noise conditions). In some examples, a device may support same-slot HARQ feedback, in which the device may provide HARQ feedback in a specific slot for data received in a previous symbol in the slot. In other cases, the device may provide HARQ feedback in a subsequent slot, or according to some other time interval.

One or more of a base station 105 or a UE 115 may support transmission of beamformed communications using one or more beams, such as transmit beams. In some cases, one or more of a base station 105 or a UE 115 may operate in an unlicensed radio frequency spectrum band. Because the unlicensed radio frequency spectrum band is shared, one or more of a base station 105 or a UE 115 may perform a contention procedure, such as a listen-before-talk procedure. As part of the listen-before-talk procedure, one or more of the base station 105 or the UE 115 may sense a channel using a sensing beam and transmit beamformed communications using a transmit beam, in response to the channel being sensed as idle. The listen-before-talk procedure may utilize an EDT to determine presence of beamformed communications from other communication devices on the channel. Based on the channel being sensed as idle, one or more of the base station 105 or the UE 115 may transmit beamformed communications using one or more transmit beams. In some cases, there may be a mismatch between a sensing beam and a transmit beam, which may impact the reliability of the beamformed communications in response to sensing an idle channel. Various aspects of the present disclosure relate to one or more of a base station 105 or a UE 115 adjusting an EDT for mismatched beams, for example a mismatch between a transmit beam and a sensing beam.

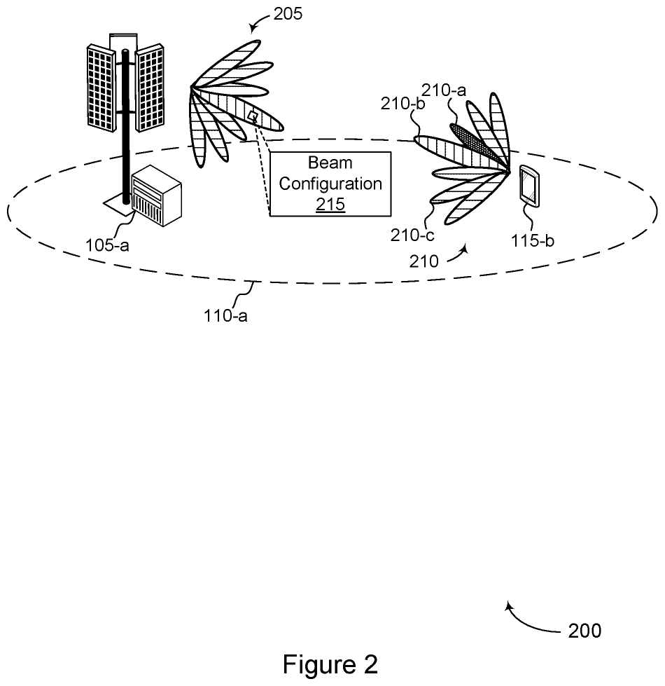

FIG. 2 illustrates an example of a wireless communications system 200 that supports EDT adjustment based on sensing and transmission beams in accordance with aspects of the present disclosure. In some examples, the wireless communications system 200 may implement aspects of the wireless communications system 100 or may be implemented by aspects of the wireless communications system 100. For example, the wireless communications system 200 may include a base station 105-a and a UE 115-a within a geographic coverage area 110-a. The base station 105-a and the UE 115-a may be examples of corresponding devices described herein with reference to FIG. 1. The wireless communications system 200 may support improvements to power consumption and may promote enhanced efficiency for higher reliability wireless communications, among other benefits.

The base station 105-a and the UE 115-a may be configured with multiple antennas, which may be used to employ techniques such as transmit diversity, receive diversity, multiple-input multiple-output communications, or beamforming, or any combination thereof. The antennas of the base station 105-a and the UE 115-a may be located within one or more antenna arrays or antenna panels, which may support multiple-input multiple-output operations or transmit or receive beamforming. The base station 105-a may have an antenna array with a quantity of rows and columns of antenna ports that the base station 105-a may use to support beamforming of communications with the UE 115-a. Likewise, the UE 115-a may have one or more antenna arrays that may support various multiple-input multiple-output or beamforming operations. Additionally or alternatively, an antenna panel may support radio frequency beamforming for a signal transmitted via one or more antenna ports. The base station 105-a and the UE 115-a may be configured to support beamformed communications over a set of beams using the multiple antennas. For example, the base station 105-a may support beamformed communications using one or more beams 205. Likewise, the UE 115-a may support beamformed communications using one more beams 210.

One or more of the base station 105-a or the UE 115-a may operate in an unlicensed radio frequency spectrum band. Because the unlicensed radio frequency spectrum band is shared between the UE 115-a and other communication devices (for example, other UEs), a communication device may perform a contention procedure, such as listen-before-talk. As part of the listen-before-talk, the UE 115-a may sense a channel using a sensing beam and transmit beamformed communication (for example, uplink beamformed transmissions) using a transmit beam, in response to the channel being sensed as idle (in other words, unoccupied by another communication device). For example, the UE 115-a may sense a channel using a sensing beam 210-a and transmit beamformed communications using a transmitting beam 210-b.

As part of the listen-before-talk, one or more of the base station 105-a or the UE 115-a may utilize an EDT to determine presence of beamformed communications from other communication devices on the channel. In some cases, there may be a mismatch between a sensing beam (for example, the sensing beam 210-a) and one or more transmitting beams (for example, the transmitting beam 210-b and the transmitting beam 210-c) due to various factors (such as, blocking), which may impact the reliability of the beamformed communications in response to sensing an idle channel. Various aspects of the present disclosure relate to one or more of the base station 105-a or the UE 115-a adjusting an EDT for mismatched beams, such as one or more of the sensing beam 210-a, the transmitting beam 210-b, and the transmitting beam 210-c. The base station 105-a may transmit a beam configuration 215 to the UE 115-a. The UE 115-a may perform EDT adjustment based at least in part on the beam configuration 215.

A transmitting beam, such as one or more of the transmitting beam 210-b or the transmitting beam 210-c may be associated with a beam gain defined as G(θ), in which G is a respective beam gain at a respective beam pointing direction θ (also referred to as an emission direction or a direction of maximum emission). In some examples, a respective transmitting beam may be associated with a maximum beam gain defined as G*=G(θ*), in which θ* is a maximum pointing direction (also referred to as a maximum emission direction). In some other examples, a respective transmitting beam may be associated with a conducted power P_{c}, which may induce an effective radiation power defined as P* and EDT according to a configuration or function. A respective sensing beam, such as the sensing beam 210-a may be associated with a beam gain defined as Gₛ(θᵢ), in which Gₛ is a respective beam gain at a respective beam pointing direction θₛ. The sensing beam 210-a may be associated with a maximum beam gain defined as Gₛ*=Gₛ(θᵢ).

In one innovative aspect, one or more of the base station 105-a or the UE 115-a may adjust an EDT, which may result in an adjusted EDT defined as EDT_{S} based at least in part on Gₛ(θᵢ*) and G*. That is, one or more of the base station 105-a or the UE 115-a may adjust an EDT based at least in part on a respective beam gain associated with a respective sensing beam and a respective beam gain associated with a respective transmitting beam. In some examples, one or more the base station 105-a or the UE 115-a may adjust an EDT based at least in part on Gₛ(θᵢ) in the θ* direction and G* in the θ* direction. That is, one or more of the base station 105-a or the UE 115-a may adjust an EDT based at least in part on a respective beam gain associated with a respective sensing beam in a pointing direction of a respective transmitting beam and a respective beam gain associated with the respective transmitting beam in the pointing direction of the respective transmitting beam. For example, the UE 115-a may adjust an EDT based at least in part on a respective beam gain associated with the sensing beam 210-a in a pointing direction of the transmitting beam 210-b or the transmitting beam 210-c, and a respective beam gain associated with the transmitting beam 210-b or the transmitting beam 210-c in the pointing direction of the transmitting beam 210-b or the transmitting beam 210-c.

One or more of the base station 105-a or the UE 115-a may adjust an EDT according to Equation (1) below.

$${EDT}_{s} = EDT + ADJ ( {G}_{s} ( {θ}^{*} ) , G ) \qquad ( 1 )$$

EDT may be a baseline EDT and ADJ(Gₛ(θ*), G*) may be a correction value. In some examples, one or more of the base station 105-a or the UE 115-a may determine ADJ(Gₛ(θ*), G*) according to Equation (2) below.

$$ADJ ( {G}_{s} ( {θ}^{*} ) , {G}^{*} ) = min ( 0 , 10 log ( \frac{{G}_{s} ( {θ}^{*} )}{{G}^{*}} ) ) \qquad ( 2 )$$

One or more of the base station 105-a or the UE 115-a may apply a log function to

$$\frac{{G}_{s} ( {θ}^{⋆} )}{{G}^{⋆}}$$

to determine ADJ(Gₛ(θ*), G*). In some examples, one or more of the base station 105-a or the UE 115-a may determine a min

$$( 0 , 10 log ( \frac{{G}_{s} ( {θ}^{⋆} )}{{G}^{⋆}} ) )$$

according to Equation (3) below.

$$\{ \begin{matrix}10 log ( \frac{{G}_{s} ( {θ}^{⋆} )}{{G}^{⋆}} ) & for {G}_{s} ( {θ}^{*} ) < {G}^{*} \\ 0 & otherwise\end{matrix} \qquad ( 3 )$$

In some examples, adjusting an EDT may be based at least in part on beam information of a sensing beam Gₛ(θ*) for all 0 at the one or more of the base station 105-a or the UE 115-a. According to one or more of Equations (1)-(3), one or more of the base station 105-a or the UE 115-a may adjust an EDT for any mismatched transmitting beam and sensing beam pair.

In another innovative aspect, one or more of the base station 105-a or the UE 115-a may adjust an EDT, which may result in an adjusted EDT defined as EDT_{S} based at least in part on Gₛ(θᵢ*) and G*. That is, one or more of the base station 105-a or the UE 115-a may adjust an EDT based at least in part on a respective beam gain associated with a respective sensing beam and a respective beam gain associated with a respective transmitting beam. In some examples, one or more the base station 105-a or the UE 115-a may adjust an EDT based at least in part on Gₛ(θᵢ*) in the θₛ* direction and G* in the θ* direction. That is, one or more of the base station 105-a or the UE 115-a may adjust an EDT based at least in part on a respective beam gain associated with a respective sensing beam in a pointing direction of the respective sensing beam and a respective beam gain associated with a respective transmitting beam in the pointing direction of the respective transmitting beam. For example, the UE 115-a may adjust an EDT based at least in part on a respective beam gain associated with the sensing beam 210-a in a pointing direction of the sensing beam 210-a, and a respective beam gain associated with the transmitting beam 210-b or the transmitting beam 210-c in the pointing direction of the transmitting beam 210-b or the transmitting beam 210-c.

One or more of the base station 105-a or the UE 115-a may adjust an EDT, according to Equation (4) below.

$$E D {T}_{s} = EDT + ADJ ( {G}_{s}^{*} , {G}^{*} ) \qquad ( 4 )$$

In some examples, one or more of the base station 105-a or the UE 115-a may determine ADJ(Gₛ*, G*), according to Equation (5) below.

$$A D J ( {G}_{s}^{*} , {G}^{*} ) = min ( 0 , 10 log ( \frac{{G}_{s}^{*}}{{G}^{*}} ) ) \qquad ( 5 )$$

One or more of the base station 105-a or the UE 115-a may apply a log function

$$\frac{{G}_{s}^{*}}{{G}^{*}}$$

to determine ADJ(Gₛ*, G*). In some examples, one or more of the base station 105-a or the UE 115-a may determine ADJ(Gₛ*, G*) according to a minimum function and a logarithmic function. In some examples, one or more of the base station 105-a or the UE 115-a may determine min

$$( 0 , 10 log ( \frac{{G}_{s} ( {θ}^{⋆} )}{{G}^{⋆}} ) ) ,$$

according to Equation (6) below.

$$\{ \begin{matrix}10 log ( \frac{{G}_{s}^{*}}{{G}^{*}} ) & for {G}_{s}^{*} < {G}^{*} \\ 0 & otherwise\end{matrix} \qquad ( 6 )$$

According to one or more of Equations (4)-(6), one or more of the base station 105-a or the UE 115-a may adjust an EDT for any mismatched transmitting beam and sensing beam pair. As such, in some examples, the EDT adjustment may be based at least in part on a maximum beam gain of a respective beam. One or more of the base station 105-a or the UE 115-a may adjust an EDT, according to Equations (4)-(6), if a respective sensing beam points to a similar direction related to a respective transmitting beam. In some examples, the adjusted EDT determined according to one or more of Equations (4)-(6), may be used under conditions. For example, a respective sensing beam pointing direction may not be more than a threshold (for example, delta degrees) from a respective transmitting beam pointing direction.

In another innovative aspect, one or more of the base station 105-a or the UE 115-a may adjust an EDT, which may result in an adjusted EDT defined as EDT_{S} based at least in part on a single sensing beam and multiple transmitting beams. For example, the UE 115-a may adjust an EDT based at least in part on the sensing beam 210-a, the transmitting beam 210-b, and the transmitting beam 210-c. One or more respective transmitting beams may have a beam gain defined as Gᵢ(θ) pointing in a direction θᵢ*, and may have a maximum beam gain Gᵢ*=Gᵢ*(θₛ*). The one or more respective transmitting beams may also be associated with a conducted power P_{c,i}, which may induce a max effective radiated power Pit and EDT; according to a configuration or function. A respective sensing beam may have a beam gain defined as Gₛ(θ) pointing in a direction θₛ*, with a maximum beam gain Gₛ*=Gₛ(θᵢ*).

One or more of the base station 105-a or the UE 115-a may adjust an EDT, according to Equation (7) below.

$$E D {T}_{s} = {min}_{i} ( E D {T}_{i} ) + A D J ( {G}_{s} ( {θ}_{i}^{*} ) ; {G}_{i}^{*} ; i = 1 , 2 , … ) \qquad ( 7 )$$

As such, one or more of the base station 105-a or the UE 115-a may determine a minimum EDTᵢ associated with each respective sensing beam and transmitting beam pair based at least in part on a minimum function. Additionally, one or more of the base station 105-a or the UE 115-a may determine a minimum of a beam correction value Gₛ(θᵢ*) associated with each respective sensing beam and transmitting beam pair based at least in part on a minimum function. The adjusted EDT (referred to herein as EDT_{S}) may be based at least in part on a respective beam gain ratio in θᵢ*. In some examples, one or more of the base station 105-a or the UE 115-a may determine ADJ(Gₛ(θᵢ*); G*; i=1, 2, . . . ), according to Equation (8) below.

$$A D J ( {G}_{s} ( {θ}_{i}^{*} ) ; {G}_{i}^{*} ; i = 1 , 2 , … ) = min ( 0 ; 10 log ( {min}_{i} \frac{{G}_{s} ( {θ}_{i}^{*} )}{{G}_{i}^{*}} ) ) \qquad ( 8 )$$

One or more of the base station 105-a or the UE 115-a may determine ADJ(Gₛ(θᵢ*); G*; i=1, 2, . . . ) according to a minimum function and a logarithmic function.

Alternatively, one or more of the base station 105-a or the UE 115-a may adjust an EDT, according to Equation (9) below.

$$E D {T}_{s} = {min}_{i} ( E D {T}_{i} + A D {J}_{i} ( {G}_{s} ( {θ}_{i}^{*} ) ; {G}_{i}^{*} ) ) \qquad ( 9 )$$

As such, one or more of the base station 105-a or the UE 115-a may jointly determine a respective minimum EDT; and a respective beam correction value Gₛ(θᵢ*) associated with each respective sensing beam and transmitting beam pair based at least in part on a minimum function. The adjusted EDT may be based at least in part on a respective beam gain ratio in θᵢ*. In some examples, one or more of the base station 105-a or the UE 115-a may determine ADJᵢ(Gₛ(θᵢ*); Gᵢ*), according to Equation (10) below.

$$A D {J}_{i} ( {G}_{s} ( {θ}_{i}^{*} ) ; {G}_{i}^{*} ) = min ( 0 ; 10 log ( \frac{{G}_{s} ( {θ}_{i}^{*} )}{{G}_{i}^{*}} ) ) \qquad ( 10 )$$

In some other examples, one or more of the base station 105-a or the UE 115-a may adjust an EDT, according to Equation (11) below.

$$E D {T}_{s} = {min}_{i} ( E D {T}_{i} ) + A D J ( {G}_{s}^{*} ; {G}_{i}^{*} ; i = 1 , 2 , … ) \qquad ( 11 )$$

One or more of the base station 105-a or the UE 115-a may determine ADJ(Gₛ*; Gᵢ*; i=1, 2, . . . ), according to Equation (12) below.

$$ADJ ( {G}_{s}^{*} ; {G}_{i}^{*} ; i = 1 , 2 , … ) = min ( 0 ; 10 log ( {min}_{i} \frac{{G}_{s}^{*}}{{G}_{i}^{*}} ) ) \qquad ( 12 )$$

The adjusted EDT may be based at least in part on a respective beam gain ratio in θᵢ* and θₛ*. Adjustment of the EDT may be based at least in part on a criterion. For example, the criterion may be that a respective sensing beam pointing direction may not be more than a threshold from each respective transmitting beam pointing direction.

In other examples, one or more of the base station 105-a or the UE 115-a may adjust an EDT, according to Equation (13) below.

$$E D {T}_{s} = {min}_{i} ( E D {T}_{i} + {ADJ}_{i} ( {G}_{s}^{*} ; {G}_{i}^{*} ) ) \qquad ( 13 )$$

One or more of the base station 105-a or the UE 115-a may determine ADJ(Gₛ*; Gᵢ*; i=1, 2, . . . ), according to Equation (14) below.

$${ADJ}_{i} ( {G}_{s}^{*} ; {G}_{i}^{*} ) = min ( 0 ; 10 log ( \frac{{G}_{s}^{*}}{{G}_{i}^{*}} ) ) \qquad ( 14 )$$

The adjusted EDT may be based at least in part on a respective beam gain ratio in θᵢ* and θₛ*. Likewise, according to Equations (13) and (14), adjustment of the EDT may be based at least in part on a criterion. For example, the criterion may be that a respective sensing beam pointing direction may not be more than a threshold from each respective transmitting beam pointing direction.

One or more of the base station 105-a or the UE 115-a may adjust an EDT, according to Equation (15) below.

$${EDT}_{s} = {min}_{i ,} ( {EDT}_{i} ) + {min}_{i , θ} ( {ADJ}_{i} ( {G}_{s} ( θ ) ; {G}_{i} ( θ ) ) ) \qquad ( 15 )$$

In Equation (15), one or more of base station 105-a or the UE 115-a may apply separate functions, such as a minimum function to determine EDTₛ. The adjusted EDTₛ may be based at least in part on a single angle θ. One or more of the base station 105-a or the UE 115-a may determine ADJᵢ(Gₛ(θ); Gᵢ(θ)), according to Equation (16) below.

$${ADJ}_{i} ( {G}_{s} ( θ ) ; {G}_{i} ( θ ) ) = min ( 0 ; 10 log ( \frac{{G}_{s} ( θ )}{{G}_{i} ( θ )} ) ) \qquad ( 16 )$$

In Equation (16), one or more of base station 105-a or the UE 115-a may apply a log function to

$$\frac{{G}_{s} ( θ )}{{G}_{i} ( θ )}$$

to determine the beam correction value (Gₛ (θ); Gᵢ(θ)).

In some other examples, one or more of the base station 105-a or the UE 115-a may adjust an EDT, according to Equation (17) below.

$${EDT}_{s} = {min}_{i , θ} ( {EDT}_{i} ( P ( θ ) ) + ( {ADJ}_{i} ( {G}_{s} ( θ ) ; {G}_{i} ( θ ) ) ) \qquad ( 17 )$$

In Equation (17), one or more of base station 105-a or the UE 115-a may apply a single function, such as a minimum function to determine EDTₛ. The adjusted EDTₛ may be based at least in part on a single angle θ. One or more of the base station 105-a or the UE 115-a may determine ADJᵢ(Gₛ(θ); Gᵢ(θ)), according to Equation (18) below.

$${ADJ}_{i} ( {G}_{s} ( θ ) ; {G}_{i} ( θ ) ) = min ( 0 ; 10 log ( \frac{{G}_{s} ( θ )}{{G}_{i} ( θ )} ) ) \qquad ( 18 )$$

In Equation (18), one or more of base station 105-a or the UE 115-a may apply a log function to

$$\frac{{G}_{s} ( θ )}{{G}_{i} ( θ )}$$

to determine the beam correction value (Gₛ(θ); Gᵢ(θ)).

Alternatively, one or more of the base station 105-a or the UE 115-a may adjust an EDT, according to Equation (19) below.

$${EDT}_{s} = {min}_{i ,} ( {EDT}_{i} ) + {min}_{i , θ , α} ( {ADJ}_{i} ( {G}_{s} ( α ) ; {G}_{i} ( θ ) ) ) \qquad ( 19 )$$

In Equation (19), one or more of base station 105-a or the UE 115-a may use separate functions, such as separate minimums functions to determine EDTₛ. The adjusted EDTₛ may be based at least in part on a respective beam gain ratio associated with two angles θ and α. One or more of the base station 105-a or the UE 115-a may determine ADJᵢ(Gₛ(α); Gᵢ(θ)), according to Equation (20) below.

$${ADJ}_{i} ( {G}_{s} ( α ) ; {G}_{i} ( θ ) ) = min ( 0 ; 10 log ( \frac{{G}_{s} ( α )}{{G}_{i} ( θ )} ) ) \qquad ( 20 )$$

In Equation (20), one or more of base station 105-a or the UE 115-a may apply a logarithmic function to the beam gain ratio

$$\frac{{G}_{s} ( α )}{{G}_{i} ( θ )}$$

to determine the beam correction value (Gₛ(α); Gᵢ(θ)). The adjusted EDT may be based at least in part on a condition. For example, a respective sensing beam pointing direction may not vary more than a threshold from each respective transmitting beam pointing direction.

Additionally or alternatively, one or more of the base station 105-a or the UE 115-a may adjust an EDT, according to Equation (21) below.

$${EDT}_{s} = {min}_{i , θ , α} ( {EDT}_{i} ( P ( θ ) ) + ( {ADJ}_{i} ( {G}_{s} ( α ) ; {G}_{i} ( θ ) ) ) \qquad ( 21 )$$

In Equation (21), one or more of base station 105-a or the UE 115-a may use a single function, such as a single minimums function to determine EDTₛ. The adjusted EDTₛ may be based at least in part on a respective beam gain ratio associated with two angles θ and α. One or more of the base station 105-a or the UE 115-a may determine ADJᵢ(Gₛ(α); Gᵢ(θ)), according to Equation (22) below.

$${ADJ}_{i} ( {G}_{s} ( α ) ; {G}_{i} ( θ ) ) = min ( 0 ; 10 log ( \frac{{G}_{s} ( α )}{{G}_{i} ( θ )} ) ) \qquad ( 22 )$$

In Equation (22), one or more of the base station 105-a or the UE 115-a may apply a logarithmic function to the respective beam gain ratio

$$\frac{{G}_{s} ( α )}{{G}_{i} ( θ )}$$

to determine the beam correction value (Gₛ(α); Gᵢ(θ)).

One or more of the base station 105-a or the UE 115-a may support minimizations over multiple angles θ and α over an entire angle Ω (for example, θ∈Θ⊆Ω), or over subsets (that is, each angle has its own subset) of the entire angle (for example, α∈A⊆Ω). In some other examples, one or more of the base station 105-a or the UE 115-a may support minimizations over the multiple angles θ and α over the entire angle Ω, or over subsets (that is, each angle has its own subset) of the entire angle Ω depending on an index i (for example, spanning a portion of the entire angle Ω in the surrounding of the pointing direction). In other words, θ∈ΘᵢΩ or α∈Aᵢ⊆Ω.

In the wireless communications system 200, one or more of the base station 105-a or the UE 115-a may adjust an EDT to improve channel sensing and increase reliability of beamformed transmission on sensed idle channels

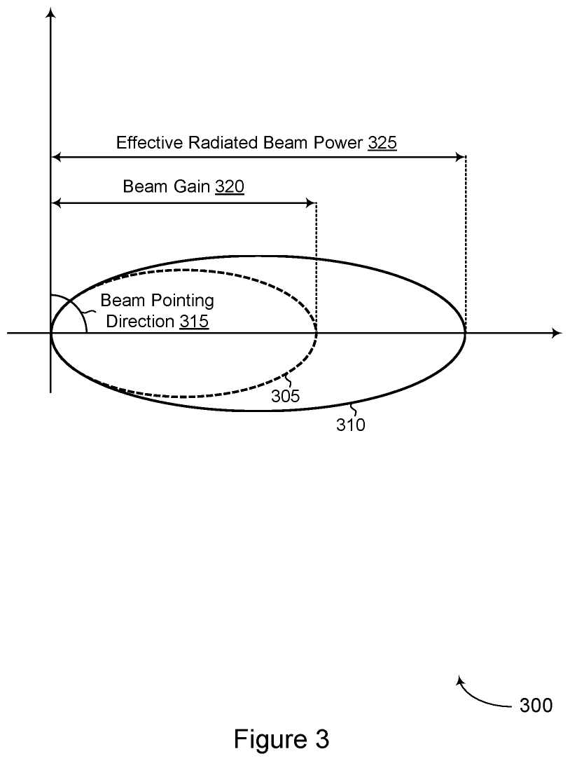

FIG. 3 illustrates an example of a beam configuration 300 that supports EDT adjustment based on sensing and transmission beams in accordance with aspects of the present disclosure. The beam configuration 300 may implement aspects of the wireless communications system 100 and the wireless communications system 200 or may be implemented by aspects of the wireless communications system 100 and the wireless communications system 200. For example, the beam configuration 300 may be implemented by one or more of a base station 105 or a UE 115, which may be examples of a base station 105 and a UE 115, as described with reference to FIGS. 1 and 2, respectively. One or more of a base station 105 or a UE 115 may support analog beamforming based at least in part on the beam configuration 300.

The beam configuration 300 may include a beam gain pattern 305 associated with a beam (such as, a sensing beam), which may be used by one or more of a base station 105 or a UE 115 for sensing operations. For example, one or more of the base station 105 or the UE 115 may sense a wireless channel using a sensing beam according to the beam gain pattern 305. The beam gain pattern 305 may be defined as G(θ), in which G is a respective beam gain at a respective beam pointing direction θ. A beam pointing direction θ may correspond to a maximum beam pointing direction.

The beam configuration 300 may include a beam power pattern 310 associated with a beam (such as, a transmitting beam), which may be used by one or more of a base station 105 or a UE 115 for wireless operations. For example, one or more of the base station 105 or the UE 115 may transmit wireless communication (for example, uplink transmissions and downlink transmissions) over a wireless channel using a transmitting beam and according to the beam power pattern 310. The beam power pattern 310 may be defined as P(θ), in which P is a respective beam power at a respective beam pointing direction θ. In some examples, the beam power pattern 310 may be based at least in part on one or more of the beam gain pattern 305 or a conducted power defined as P_{c}.

The beam configuration 300 may include a beam pointing direction 315. The beam pointing direction 315 may be defined as θ*. In some examples, one or more of a base station 105 or a UE 115 may determine a maximum beam pointing direction. For example, the beam pointing direction 315 may be a maximum beam pointing direction, and may be defined by the following expression: arg [symbol] G(Θ), in which G is a respective beam gain at a respective beam pointing direction θ and argmax may be an operation that determines a maxima value of a function.

The beam gain pattern 305 may be associated with a beam gain 320, which may be a maximum beam gain for the beam gain pattern 305. A bam gain may be defined as G*=G (θ*), in which G* is a respective maximum beam gain, G is a respective beam gain, and θ*is a respective maximum beam pointing direction. The beam power pattern 310 may be associated with an effective radiated beam power 325, which may be a maximum effective radiated beam power for the beam power pattern 310. An effective radiated beam power may be defined as P*=P (θ*), in which P* is a respective maximum effective radiated beam power, P is a respective beam power, and θ* is a respective maximum beam pointing direction.

A UE 115 may perform a channel contention procedure, such as a listen-before-talk procedure to access a wireless channel based at least in part on the beam configuration 300. As part of the listen-before-talk procedure, the UE 115 determine an availability of the wireless channel based at least in part on an EDT. In some cases, a base station 105 may define an EDT for the listen-before-talk procedure over a respective radio frequency spectrum band (such as, 60 GHz). For example, the base station 105 may define the EDT for the listen-before-talk procedure according to Equation (23) below.

$$- 80 dBm + 10 \times log 10 ( BW ) + 10 \times log 10 ( 40 dBm / {P}^{*} ) \qquad ( 23 )$$

The bandwidth (BW) may be a BW or BWP (for example, respective shared radio frequency spectrum band) associated with the listen-before-talk, and P* may be a respective maximum effective radiated beam power. Alternatively, the base station 105 may define the EDT threshold for the listen-before-talk procedure according to Equation (24) below.

$$- 80 dBm + 10 \times log 10 ( BW ) + 10 \times log 10 ( 40 dBm / ( {G}^{*} + {P}_{c} ) ) \qquad ( 24 )$$

The BW may be a respective radio frequency spectrum band associated with the listen-before-talk, G* may be a respective maximum beam gain, and P_{C} may be a conducted power. According to Equation (24), the EDT threshold may be a biproduct of a beam gain pattern and a conducted power for transmission.

In some cases, a base station 105 may configure an EDT based at least in part on that a respective transmitting beam and a respective sensing beam match. In other words, a base station 105 may be configured based on a beam gain pattern G(θ) of a respective transmitting beam and a respective sensing beam matching. In some cases, however, there may be a mismatch between a beam gain pattern G(θ) of a respective transmitting beam and a respective sensing beam. This may impact the reliability of sensing operations on the sensing beam, as well as wireless communication on the transmitting beam. Various aspects of the present disclosure relate to one or more of a base station 105 or a UE 115 adjusting an EDT if there is a mismatch between a respective transmitting beam and a respective sensing beam. For example, one or more of a base station 105 or a UE 115 may determine a correction to an EDT to determine an EDT_{S} for a mismatched transmitting beam and sensing beam as described with reference to FIG. 2.

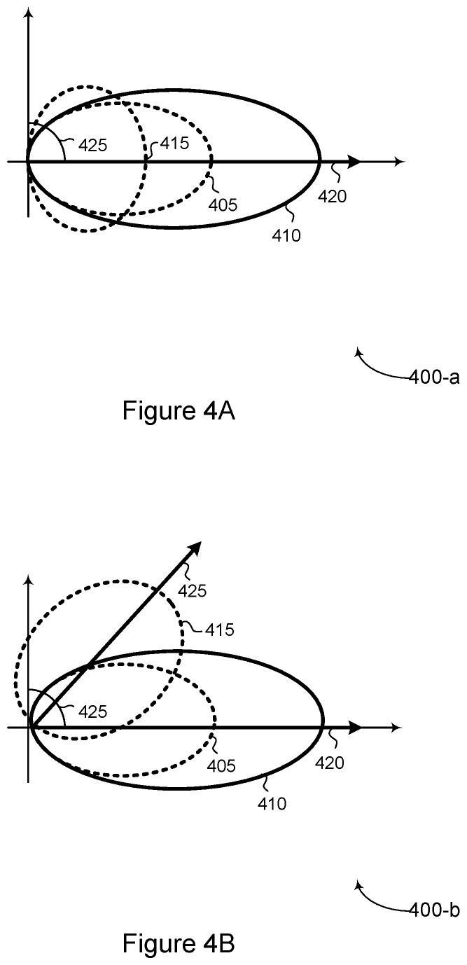

FIG. 4A illustrates an example of a beam configuration 400-a that supports an EDT adjustment based on sensing and transmission beams in accordance with aspects of the present disclosure. The beam configuration 400-a may implement aspects of the wireless communications system 100 and the wireless communications system 200 or may be implemented by aspects of the wireless communications system 100 and the wireless communications system 200. For example, the beam configuration 400-a may be implemented by one or more of a base station 105 or a UE 115, which may be examples of a base station 105 and a UE 115, as described with reference to FIGS. 1 and 2, respectively.

The beam configuration 400-a may include a beam gain pattern 405 associated with a sensing beam, which may be used by one or more of a base station 105 or a UE 115 for sensing operations. The beam gain pattern 405 may be defined as G(θ), in which G is a respective beam gain at a respective beam pointing direction θ. A respective beam pointing direction θ may correspond to a respective maximum beam pointing direction. The beam configuration 400-a may include a beam power pattern 410 associated with a respective transmitting beam, which may be used by one or more of a base station 105 or a UE 115 for wireless operations. The beam power pattern 410 may be defined as P(θ), in which P is a respective beam power at a respective beam pointing direction θ.

In the example of FIG. 4A, a respective sensing beam associated with the beam gain pattern 405 and a respective transmitting beam associated with the beam power pattern 410 may have the same beam pointing direction 420. One or more of a base station 105 or a UE 115 may determine an EDTₛ for the respective sensing beam by adjusting a baseline EDT. In some examples, the EDTₛ may be less than the baseline EDT (in other words, EDTₛ<EDT). Based at least in part on the adjusted EDT (for example, EDTₛ), the beam gain pattern 405 associated with the respective sensing beam may be adjusted to a beam gain pattern 415. As such, the respective sensing beam may have the beam gain pattern 415, which may be defined as Gₛ(θ), in which G is a respective beam gain at a respective beam pointing direction θ. The adjusted baseline EDT (for example, EDTₛ) may have a respective beam pointing direction θₛ*, which may be the same as a maximum beam pointing direction θ*. Various aspects of the present disclosure relate to one or more of a base station 105 or a UE 115 adjusting an EDT if there is a mismatch between a respective transmitting beam and a respective sensing beam. For example, as illustrated in FIG. 4A, one or more of a base station 105 or a UE 115 may determine a correction to an EDT to determine an EDTₛ for a mismatched transmitting beam and sensing beam as described with reference to FIG. 2.

FIG. 4B illustrates an example of a beam configuration 400-b that supports an EDT adjustment based on sensing and transmission beams in accordance with aspects of the present disclosure. The beam configuration 400-b may implement aspects of the wireless communications system 100 and the wireless communications system 200 or may be implemented by aspects of the wireless communications system 100 and the wireless communications system 200. For example, the beam configuration 400-b may be implemented by one or more of a base station or a UE 115, which may be examples of a base station 105 and a UE 115, as described with reference to FIGS. 1 and 2, respectively.

The beam configuration 400-b may include a beam gain pattern 405 associated with a respective sensing beam, which may be used by one or more of a base station 105 or a UE 115 for sensing operations. The beam gain pattern 405 may be defined as G(θ), in which G is a respective beam gain at a respective beam pointing direction θ. A beam pointing direction θ may correspond to a respective maximum beam pointing. The beam configuration 400-b may include a beam power pattern 410 associated with a respective transmitting beam, which may be used by one or more of a base station 105 or a UE 115 for wireless operations. The beam power pattern 410 may be defined as P(θ), in which P is a respective beam power at a respective beam pointing direction θ.

In the example of FIG. 4B, a respective sensing beam associated with the beam gain pattern 405 and a respective transmitting beam associated with the beam power pattern 410 may have the same beam pointing direction 420. One or more of a base station 105 or a UE 115 may determine an EDTₛ for the sensing beam by adjusting a baseline EDT. In some examples, the EDTₛ may be less than the baseline EDT (in other words, EDTₛ<EDT). Based at least in part on the adjusted baseline EDT, the beam gain pattern 405 may be adjusted to a beam gain pattern 415. As such, the respective sensing beam may have the beam gain pattern 415, which may be defined as Gₛ(θ), in which G is a respective beam gain at a respective beam pointing direction θ. The beam gain pattern 415 may have a beam pointing direction 425. In other words, the adjusted EDT (for example, EDTₛ) may be associated with a beam pointing direction θₛ*, which may be different than a maximum beam pointing direction θ*.

A respective sensing beam may have a beam pointing direction in a direction different than a beam pointing direction of a respective transmitting beam, as well as a maximum beam pointing direction θ*. In some examples, a respective sensing beam may have a beam pointing direction in a direction that is different than a beam pointing direction of a respective transmitting beam, as well as a maximum beam pointing direction θ* by a threshold. In other words, the respective sensing beam may be pointed in any direction according to a threshold adjustment. In some examples, the more the pointing directions of a respective sensing beam and a respective transmitting beam diverge, the larger the EDT correction. This may, in some cases, result in amplified spurious interference in the pointing direction of the sensing beam. Various aspects of the present disclosure relate to one or more of a base station 105 or a UE 115 adjusting an EDT if there is a mismatch between a respective transmitting beam and a respective sensing beam. For example, one or more of a base station 105 or a UE 115 may determine a correction to an EDT to determine an EDTₛ for a mismatched transmitting beam and sensing beam as described with reference to FIG. 2.

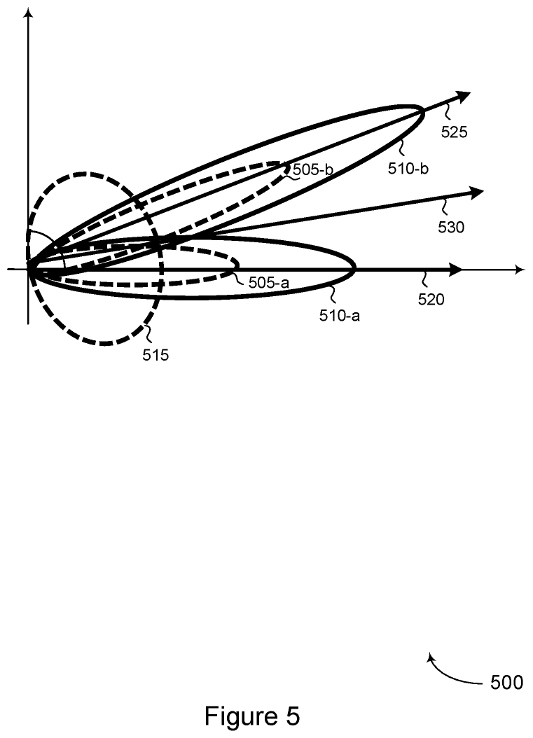

FIG. 5 illustrates an example of a beam configuration 500 that supports an EDT adjustment based on sensing and transmission beams in accordance with aspects of the present disclosure. The beam configuration 500 may implement aspects of the wireless communications system 100 and the wireless communications system 200 or may be implemented by aspects of the wireless communications system 100 and the wireless communications system 200. For example, the beam configuration 500 may be implemented by one or more of a base station 105 or a UE 115, which may be examples of a base station 105 and a UE 115, as described with reference to FIGS. 1 and 2, respectively. In the example of FIG. 5, one or more of a base station 105 or a UE 115 may use a single sensing beam and multiple transmitting beams, for example, to cover a synchronization signal block burst.

The beam configuration 500 may include a beam gain pattern 505 associated with a respective sensing beam, which may be used by one or more of a base station 105 or a UE 115 for sensing operations. The beam gain pattern 505 may be defined as G(θ), in which G is a respective beam gain at a respective beam pointing direction θ. For example, a beam gain pattern 505-a may be defined as G₁(θ1), in which G₁ is a respective beam gain at a respective beam pointing direction θ1. Additionally, a beam gain pattern 505-b may be defined as G₂(θ2), in which G₂ is a respective beam gain at a respective beam pointing direction θ2.

The beam configuration 500 may include a beam power pattern 510 associated with a respective transmitting beam, which may be used by one or more of a base station 105 or a UE 115 for wireless operations. The beam power pattern 510 may be defined as P(θ), in which P is a respective beam power at a respective beam pointing direction θ. For example, a beam power pattern 510-a may be defined as P₁(θ₁), in which P₁ is a respective beam power at a respective beam pointing direction θ₁. Additionally, a beam power pattern 510-b may be defined as P₂(θ₂), in which P₂ is a respective beam power at a respective beam pointing direction θ₂. The beam power pattern 510-a may correspond to a maximum beam pointing direction 520, which may be defined as θ₁*. A respective sensing beam and a respective transmitting beam may be associated with the same maximum beam pointing direction 520. The beam power pattern 510-b may correspond to a maximum beam pointing direction 525, which may be defined as θ₂*. Likewise, a respective sensing beam and a respective transmitting beam may be associated with the same maximum beam pointing direction 525.

One or more of a base station 105 or a UE 115 may determine an EDTₛ for a single sensing beam by adjusting a baseline EDT. In the example of FIG. 5, one or more of a base station 105 or a UE 115 may determine an EDTₛ for a single sensing beam based at least in part on an EDT (for example, EDT₁) associated with one or more of the beam gain pattern 505-a or the beam power pattern 510-a. Additionally or alternatively, one or more of a base station 105 or a UE 115 may determine an EDTₛ for a single sensing beam based at least in part on an EDT (for example, EDT₂) associated with one or more of the beam gain pattern 505-b or the beam power pattern 510-b. In some examples, the EDTₛ may be less than one or more baseline EDTₛ (in other words, EDTₛ<EDT₁ and EDTₛ<EDT₂). Based at least in part on the adjusted baseline EDT, the beam gain pattern 505 may be adjusted to a beam gain pattern 515. As such, the sensing beam may have the beam gain pattern 515, which may be defined as Gₛ(θ), in which G is a respective beam gain at a respective beam pointing direction θ. The beam gain pattern 515 may have a beam pointing direction 530. In other words, the adjusted EDT (for example, EDTₛ) may be associated with a beam pointing direction θₛ*, which may be different than θ₁* and θ₂*.

The beam configuration 500 supports EDT adjustment in case of multiple transmitting beams with a single sensing beam (that is, Gᵢ(θ); i=1, 2, . . . to be covered with Gₛ(θ)). In some examples, Gₛ(θ) and EDTₛ may be as sensitive as any pair of {Gᵢ(θ), EDTᵢ} in any direction of maximum pointing θᵢ*. In some examples, one or more of a base station 105 may determine one or more beam parameters (for example, a pointing direction) of a sensing beam, and may transmit an indication of the one or more parameters to a UE 115. In some other examples, one or more of a base station 105 or a UE 115 may be configured with one or more beam parameters of a sensing beam and a transmitting beam. As such, one or more of the base station 105 or the UE 115 may focus resources (for example, processing resources) to determine an EDT correction to provide reliable transmissions on transmitting beams.

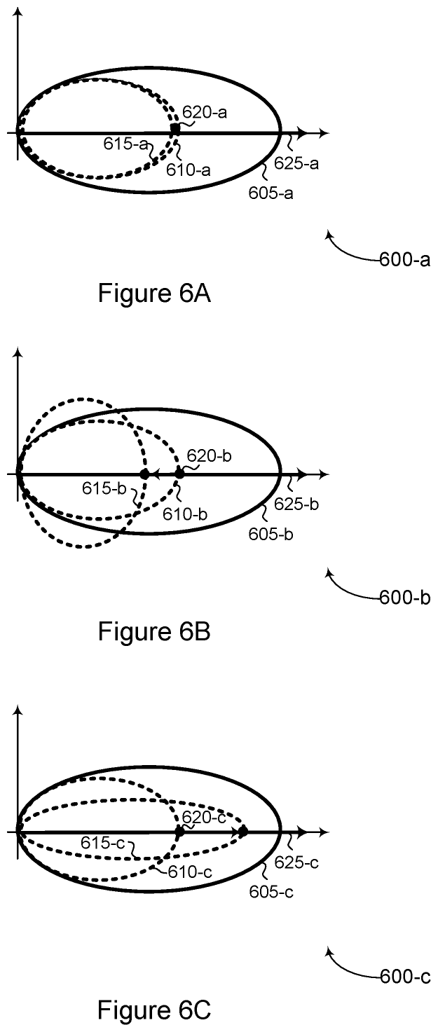

FIG. 6A illustrates an example of a beam configuration 600-a that supports an EDT adjustment based on sensing and transmission beams in accordance with aspects of the present disclosure. The beam configuration 600-a may implement aspects of the wireless communications system 100 and the wireless communications system 200 or may be implemented by aspects of the wireless communications system 100 and the wireless communications system 200. For example, the beam configuration 600-a may be implemented by one or more of a base station 105 or a UE 115, which may be examples of a base station 105 and a UE 115, as described with reference to FIGS. 1 and 2, respectively.

One or more of a base station 105 or a UE 115 may perform wireless communication using a respective transmitting beam associated with a beam gain pattern 605-a defined as G(θ), in which G is a respective beam gain at a respective beam pointing direction θ. The transmitting beam may be associated with a maximum beam gain defined as G*=G (θ*) and conductive power P_{C}, in which θ* is a maximum pointing direction. The transmitting beam may induce a maximum beam power P* and EDT according to a configuration. One or more of a base station 105 or a UE 115 may also perform sensing operations using a sensing beam associated with a beam gain pattern 610-a defined as Gₛ(θ), in which Gₛ is a respective beam gain at a respective beam pointing direction θ. The sensing beam may be associated with a maximum beam gain defined as Gₛ*=Gₛ(θₛ*).

One or more a base station 105 or a UE 115 may adjust an EDT, for example, to determine a EDTₛ associated with the sensing beam as described with reference to FIG. 2. For example, one or more a base station 105 or a UE 115 may adjust an EDT for a sensing beam associated with the beam gain pattern 610-a. Based at least in part on the adjusted EDT, the beam gain pattern 610-a may be adjusted to a beam gain pattern 615-a. A delta beam gain 620-a may result based at least in part on the adjusted EDT. In other words, a maximum beam gain associated with the beam gain pattern 610-a may be different by a threshold than a maximum beam gain associated with the beam gain pattern 615-a. According to the beam configuration 600-a, Gₛ*=Gₛ(θₛ*)=G*, and θₛ*=θ*. In other words, a maximum beam gain associated with the sensing beam may be the same as a beam gain associated with the transmitting beam, while the pointing directions 625-a of each of the sensing beam and the transmitting beam are the same.

FIG. 6B illustrates an example of a beam configuration 600-b that supports an EDT adjustment based on sensing and transmission beams in accordance with aspects of the present disclosure. The beam configuration 600-b may implement aspects of the wireless communications system 100 and the wireless communications system 200 or may be implemented by aspects of the wireless communications system 100 and the wireless communications system 200. For example, the beam configuration 600-b may be implemented by one or more of a base station 105 or a UE 115, which may be examples of a base station 105 and a UE 115, as described with reference to FIGS. 1 and 2, respectively.

One or more of a base station 105 or a UE 115 may perform wireless communication using a transmitting beam associated with a beam gain pattern 605-b defined as G(θ), in which G is a respective beam gain at a respective beam pointing direction θ. The transmitting beam may be associated with a maximum beam gain defined as G*=G (θ*) and conductive power P_{C}, in which θ* is a maximum pointing direction. The transmitting beam may induce a maximum beam power P* and EDT according to a configuration. One or more of a base station 105 or a UE 115 may also perform sensing operations using a sensing beam associated with a beam gain pattern 610-b defined as Gₛ(θ), in which G is a respective beam gain at a respective beam pointing direction θ. The sensing beam may be associated with a maximum beam gain defined as Gₛ*=Gₛ(θₛ*).

One or more a base station 105 or a UE 115 may adjust an EDT, for example, to determine an EDTₛ associated with the sensing beam as described with reference to FIG. 2. For example, one or more a base station 105 or a UE 115 may adjust an EDT for a sensing beam associated with the beam gain pattern 610-b. Based at least in part on the adjusted EDT, the beam gain pattern 610-b may be adjusted to a beam gain pattern 615-b. A delta beam gain 620-b may result based at least in part on the adjusted EDT. In other words, a maximum beam gain associated with the beam gain pattern 610-b may be different by a threshold than a maximum beam gain associated with the beam gain pattern 615-b. According to the beam configuration 600-b, Gₛ*=Gₛ(θᵢ*)<G*, and θₛ=θ*. In other words, a maximum beam gain associated with the sensing beam may be less than a beam gain associated with the transmitting beam, while the pointing directions 625-b of each of the sensing beam and the transmitting beam are the same.

FIG. 6C illustrates an example of a beam configuration 600-c that supports an EDT adjustment based on sensing and transmission beams in accordance with aspects of the present disclosure. The beam configuration 600-c may implement aspects of the wireless communications system 100 and the wireless communications system 200 or may be implemented by aspects of the wireless communications system 100 and the wireless communications system 200. For example, the beam configuration 600-c may be implemented by one or more of a base station 105 or a UE 115, which may be examples of a base station 105 and a UE 115, as described with reference to FIGS. 1 and 2, respectively.

One or more of a base station 105 or a UE 115 may perform wireless communication using a transmitting beam associated with a beam gain pattern 605-c defined as G(θ), in which G is a respective beam gain at a respective beam pointing direction θ. The transmitting beam may be associated with a maximum beam gain defined as G*=G (θ*) and conductive power P_{C}, in which θ* is a maximum pointing direction. The transmitting beam may induce a maximum beam power P* and EDT according to a configuration. One or more of a base station 105 or a UE 115 may also perform sensing operations using a sensing beam associated with a beam gain pattern 610-c defined as Gₛ(θ), in which G is a respective beam gain at a respective beam pointing direction θ. The sensing beam may be associated with a maximum beam gain defined as Gₛ=Gₛ(θₛ*).

One or more a base station 105 or a UE 115 may adjust an EDT, for example, to determine an EDTₛ associated with the sensing beam as described with reference to FIG. 2. For example, one or more a base station 105 or a UE 115 may adjust an EDT for a sensing beam associated with the beam gain pattern 610-c. Based at least in part on the adjusted EDT, the beam gain pattern 610-c may be adjusted to a beam gain pattern 615-c. A delta beam gain 620-c may result based at least in part on the adjusted EDT. According to the beam configuration 600-c, Gₛ*=Gₛ(θᵢ*)>G*, and θₛ*=θ*. In other words, a maximum beam gain associated with the sensing beam may be greater than a beam gain associated with the transmitting beam, while the pointing directions 625-c of each of the sensing beam and the transmitting beam are the same. In this case, one or more of a base station 105 or a UE 115 may refrain from correcting the EDT (that is, adjustment of the EDT) because it would result in unnecessary amplification of the sensing beam.

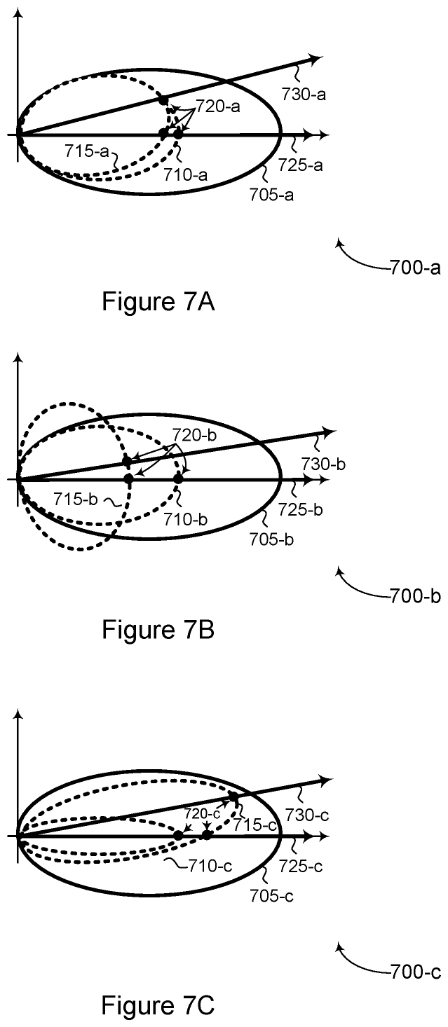

FIG. 7A illustrates an example of a beam configuration 700-a that supports an EDT adjustment based on sensing and transmission beams in accordance with aspects of the present disclosure. The beam configuration 700-a may implement aspects of the wireless communications system 100 and the wireless communications system 200 or may be implemented by aspects of the wireless communications system 100 and the wireless communications system 200. For example, the beam configuration 700-a may be implemented by one or more of a base station 105 or a UE 115, which may be examples of a base station 105 and a UE 115, as described with reference to FIGS. 1 and 2, respectively.

One or more of a base station 105 or a UE 115 may perform wireless communication using a transmitting beam associated with a beam gain pattern 705-a defined as G(θ), in which G is a respective beam gain at a respective beam pointing direction θ. The transmitting beam may be associated with a maximum beam gain defined as G*=G (θ*) and conductive power P_{C}, in which θ* is a maximum pointing direction. One or more of a base station 105 or a UE 115 may also perform sensing operations using a sensing beam associated with a beam gain pattern 710-a defined as Gₛ(θ), in which G is a respective beam gain at a respective beam pointing direction θ. The sensing beam may be associated with a maximum beam gain defined as Gₛ*=Gₛ(θₛ*). In some examples, prior to an EDT adjustment the pointing directions of the transmitting beam and the sensing beam may be the same.

One or more a base station 105 or a UE 115 may adjust an EDT, for example, to determine a EDTₛ associated with the sensing beam as described with reference to FIG. 2. For example, one or more a base station 105 or a UE 115 may adjust an EDT for a sensing beam associated with the beam gain pattern 710-a. Based at least in part on the adjusted EDT, the beam gain pattern 710-a may be adjusted to a beam gain pattern 715-a. A delta beam gain 720-a may result based at least in part on the adjusted EDT. In other words, a maximum beam gain associated with the beam gain pattern 710-a may be different by a threshold than a maximum beam gain associated with the beam gain pattern 715-a. According to the beam configuration 700-a, Gₛ*, Gₛ(θₛ*), G*, and θₛ*≠θ*. In other words, a maximum beam gain associated with the sensing beam may be different than as a beam gain associated with the transmitting beam. Additionally, the pointing directions of each of the sensing beam and the transmitting beam may be different. For example, a pointing direction 725-a associated with the transmitting beam may be different than a pointing direction 730-a associated with the sensing beam.

FIG. 7B illustrates an example of a beam configuration 700-b that supports an EDT adjustment based on sensing and transmission beams in accordance with aspects of the present disclosure. The beam configuration 700-b may implement aspects of the wireless communications system 100 and the wireless communications system 200 or may be implemented by aspects of the wireless communications system 100 and the wireless communications system 200. For example, the beam configuration 700-b may be implemented by one or more of a base station 105 or a UE 115, which may be examples of a base station 105 and a UE 115, as described with reference to FIGS. 1 and 2, respectively.

One or more of a base station 105 or a UE 115 may perform wireless communication using a transmitting beam associated with a beam gain pattern 705-b defined as G(θ), in which G is a respective beam gain at a respective beam pointing direction θ. The transmitting beam may be associated with a maximum beam gain defined as G*=G (θ*) and conductive power P_{C}, in which θ* is a maximum pointing direction. One or more of a base station 105 or a UE 115 may also perform sensing operations using a sensing beam associated with a beam gain pattern 710-b defined as Gₛ(θ), in which G is a respective beam gain at a respective beam pointing direction θ. The sensing beam may be associated with a maximum beam gain defined as Gₛ=Gₛ(θᵢ*).

One or more a base station 105 or a UE 115 may adjust an EDT, for example, to determine an EDTₛ associated with the sensing beam as described with reference to FIG. 2. For example, one or more a base station 105 or a UE 115 may adjust an EDT for a sensing beam associated with the beam gain pattern 710-b. Based at least in part on the adjusted EDT, the beam gain pattern 710-b may be adjusted to a beam gain pattern 715-b. A delta beam gain 720-b may result based at least in part on the adjusted EDT. In other words, a maximum beam gain associated with the beam gain pattern 710-b may be different by a threshold than a maximum beam gain associated with the beam gain pattern 715-b. According to the beam configuration 700-b, Gₛ*, Gₛ(θᵢ*), G*, and θₛ*≠θ*. A maximum beam gain associated with the sensing beam may thus be different than as a beam gain associated with the transmitting beam. Additionally, the pointing directions of each of the sensing beam and the transmitting beam may be different. For example, a pointing direction 725-b associated with the transmitting beam may be different than a pointing direction 730-b associated with the sensing beam. In some examples, prior to the EDT adjustment the pointing directions of the transmitting beam and the sensing beam may be the same.

FIG. 7C illustrates an example of a beam configuration 700-c that supports an EDT adjustment based on sensing and transmission beams in accordance with aspects of the present disclosure. The beam configuration 700-c may implement aspects of the wireless communications system 100 and the wireless communications system 200 or may be implemented by aspects of the wireless communications system 100 and the wireless communications system 200. For example, the beam configuration 700-c may be implemented by one or more of a base station 105 or a UE 115, which may be examples of a base station 105 and a UE 115, as described with reference to FIGS. 1 and 2, respectively.

One or more of a base station 105 or a UE 115 may perform wireless communication using a transmitting beam associated with a beam gain pattern 705-c defined as G(θ), in which G is a respective beam gain at a respective beam pointing direction θ. The transmitting beam may be associated with a maximum beam gain defined as G*=G (θ*) and conductive power P_{C}, in which θ* is a maximum pointing direction. One or more of a base station 105 or a UE 115 may also perform sensing operations using a sensing beam associated with a beam gain pattern 710-c defined as Gₛ(θ), in which G is a respective beam gain at a respective beam pointing direction θ. The sensing beam may be associated with a maximum beam gain defined as Gₛ=Gₛ(θₛ*).

One or more a base station 105 or a UE 115 may adjust an EDT, for example, to determine an EDTₛ associated with the sensing beam as described with reference to FIG. 2. For example, one or more a base station 105 or a UE 115 may adjust an EDT for a sensing beam associated with the beam gain pattern 710-c. Based at least in part on the adjusted EDT, the beam gain pattern 710-c may be adjusted to a beam gain pattern 715-c. A delta beam gain 720-c may result based at least in part on the adjusted EDT. In other words, a maximum beam gain associated with the beam gain pattern 710-c may be different by a threshold than a maximum beam gain associated with the beam gain pattern 715-c.

According to the beam configuration 700-c, Gₛ, Gₛ(θₛ*), G*, and θₛ*≠θ*. A maximum beam gain associated with the sensing beam may thus be different than as a beam gain associated with the transmitting beam. Additionally, the pointing directions of each of the sensing beam and the transmitting beam may be different. For example, a pointing direction 725-c associated with the transmitting beam may be different than a pointing direction 730-c associated with the sensing beam. In some examples, before the EDT adjustment the pointing directions of the transmitting beam and the sensing beam may be the same. In some examples, based at least in part on the beam configuration 600-c, one or more of a base station 105 or a UE 115 may refrain from adjusting the EDT because it would result in unnecessary amplification of the sensing beam.

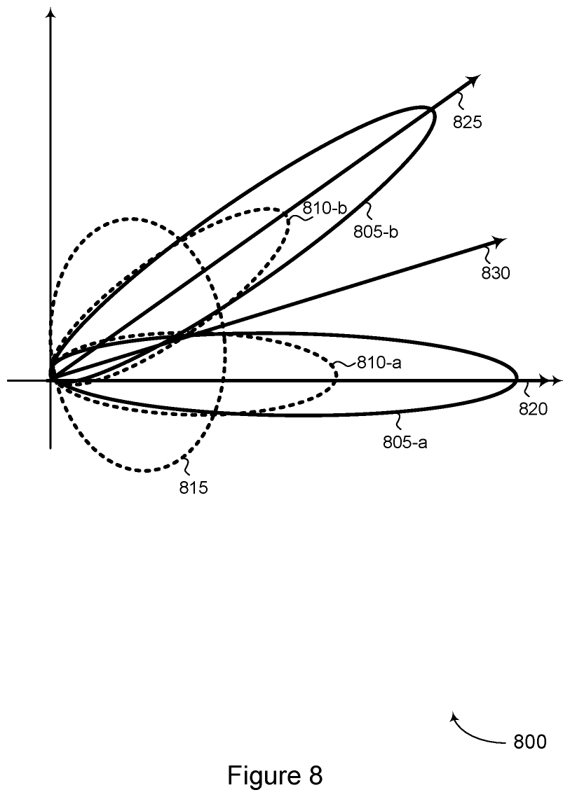

FIG. 8 illustrates an example of a beam configuration 800 that supports an EDT adjustment based on sensing and transmission beams in accordance with aspects of the present disclosure. The beam configuration 800 may implement aspects of the wireless communications system 100 and the wireless communications system 200 or may be implemented by aspects of the wireless communications system 100 and the wireless communications system 200. For example, the beam configuration 800 may be implemented by one or more of a base station 105 or a UE 115, which may be examples of a base station 105 and a UE 115, as described with reference to FIGS. 1 and 2, respectively.

One or more of a base station 105 or a UE 115 may perform wireless communication using a transmitting beam associated with a beam gain pattern 805 defined as G(θ), in which G is a respective beam gain at a respective beam pointing direction θ. The transmitting beam may be associated with a maximum beam gain defined as G*=G(θ*), in which θ* is a maximum pointing direction. In the example of FIG. 8, the beam configuration 800 may include a transmitting beam associated with a beam gain pattern 805-a defined as G₁(θ₁), in which G₁ is a beam gain associated with the beam pointing direction θ₁. The beam pointing direction θ₁ may be a maximum beam pointing direction 820. The beam configuration 800 may include a transmitting beam associated with a beam gain pattern 805-b defined as G₂(θ2), in which G₂ is a beam gain associated with the beam pointing direction θ2. The beam pointing direction θ₂ may be a maximum beam pointing direction 825.

One or more of a base station 105 or a UE 115 may also perform sensing operations using a sensing beam associated with a beam gain pattern 810 defined as Gₛ (θₛ), in which Gₛ is a respective beam gain at a respective beam pointing direction Os. The sensing beam may be associated with a maximum beam gain defined as Gₛ*=Gₛ(θₛ*). In the example of FIG. 8, the beam configuration 800 may include a sensing beam associated with a beam gain pattern 810-a defined as Gₛ(θ₁*), in which Gₛ is a beam gain associated with the beam pointing direction θ₁. The beam pointing direction θ₁* may be a maximum beam pointing direction 820 prior to ETD adjustments. The beam configuration 800 may also include a sensing beam associated with a beam gain pattern 810-b defined as Gₛ(θ₂*), in which Gₛ is a beam gain associated with the beam pointing direction θ₂*. The beam pointing direction θ₂*may be a maximum beam pointing direction 825 prior to ETD adjustments

One or more a base station 105 or a UE 115 may adjust an EDT, for example, to determine an EDTₛ associated with the sensing beam as described with reference to FIG. 2. For example, one or more a base station 105 or a UE 115 may adjust an EDT for a sensing beam associated with the beam gain pattern 810-a and the beam gain pattern 810-b. Based at least in part on the adjusted EDT, the beam gain pattern 810-a and the beam gain pattern 810-b may be adjusted to a beam gain pattern 815. A beam pointing direction θₛ* associated with the beam gain pattern 815 may be in a maximum beam pointing direction 830.

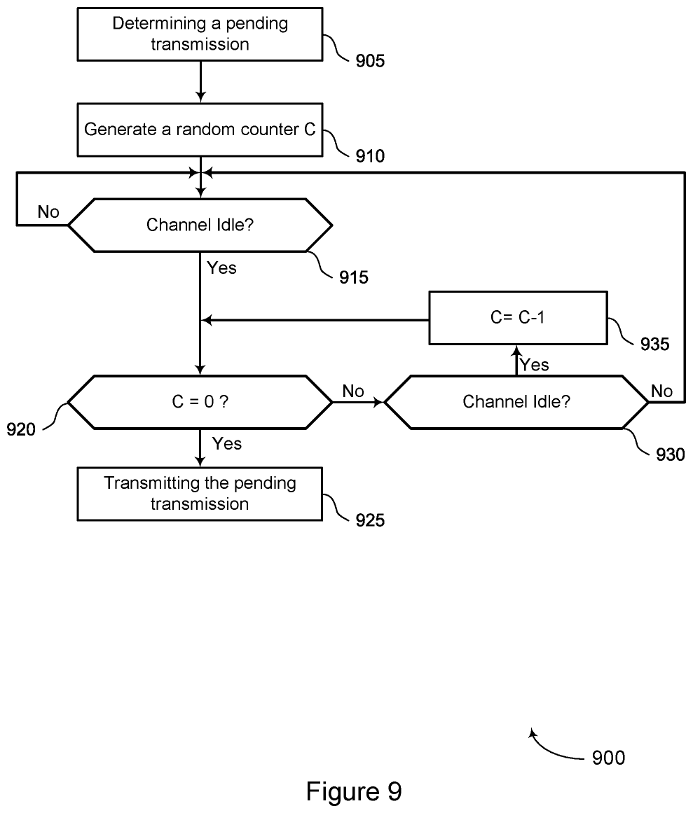

FIG. 9 illustrates an example of a method 900 that supports an EDT adjustment based on sensing and transmission beams in accordance with aspects of the present disclosure. The method 900 may implement aspects of the wireless communications system 100 and the wireless communications system 200 or may be implemented by aspects of the wireless communications system 100 and the wireless communications system 200. For example, the method 900 may be based on a configuration by a base station 105, which may be implemented by a UE 115. The base station 105 and the UE 115 may be examples of a base station 105 and a UE 115, as described with reference to FIGS. 1 and 2.

In the example of FIG. 9, the method 900 may be a channel access procedure. If operating in an unlicensed spectrum, one or more of a base station 105 or a UE 115 may periodically check for presence of other occupants on a channel (for example, listen) before transmitting (for example, talk). One or more of a base station 105 or a UE 115 may perform a listen-before-talk. The listening time is referred to as a CCA duration. To initiate a channel occupancy time (COT), one or more of a base station 105 or a UE 115 may perform the CCA. If one or more of a base station 105 or a UE 115 wants to transmit, the base station 105 or the UE 115 may detect an energy level for a duration equal to the CCA duration. If the energy level of the channel is below a CCA threshold, then the base station 105 or the UE 115 can transmit for duration equal to the COT. After that, if the base station 105 or the UE 115 wants to continue its transmission, the base station 105 or the UE 115 may repeat the CCA.

At 905, one or more of a base station 105 or a UE 115 may determine a pending transmission (for example, a downlink transmission or an uplink transmission). At 910, one or more of the base station 105 or the UE 115 may generate a random counter C. For example, one or more of the base station 105 or the UE 115 may generate a random counter C based at least in part on selecting a random number form a range of numbers (for example, between a minimum number and a maximum number). At 915, one or more of the base station 105 or the UE 115 may determine whether a channel is idle within an observation window, for example of 8 μs. If one or more of the base station 105 or the UE 115 determines that the channel is not idle within the observation window (for example, CCA duration), the one or more of the base station 105 or the UE 115 may repeat the operations at 915. Otherwise, at 920, one or more of the base station 105 or the UE 115 may determine whether the random counter C value is equal to zero.

In the example of FIG. 9, if one or more of the base station 105 or the UE 115 may determine that the random counter C value is equal to zero, one or more of the base station 105 or the UE 115 may transmit, at 925, the pending transmission. Otherwise, one or more of the base station 105 or the UE 115 may determine, at 930, whether the channel is idle within an observation window, for example of 5 μs. If one or more of the base station 105 or the UE 115 determines that the channel is not idle within the observation window (for example, CCA duration), the one or more of the base station 105 or the UE 115 may repeat the operations at 915. Otherwise, one or more of the base station 105 or the UE 115 may decrement the random counter C (for example, C=C−1).

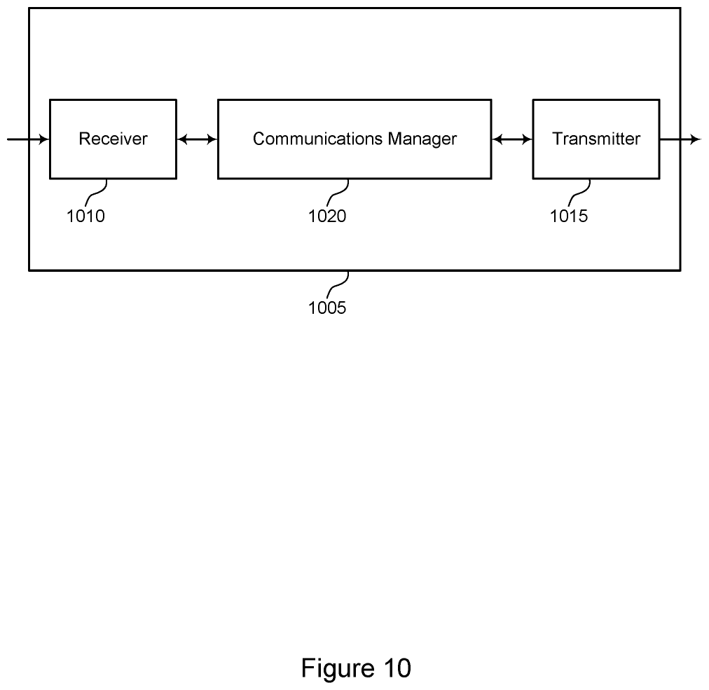

FIG. 10 shows a block diagram of a device 1005 that supports EDT adjustment based on sensing and transmission beams in accordance with aspects of the present disclosure. The device 1005 may be an example of aspects of one or more of a base station 105 or a UE 115. The device 1005 may include a receiver 1010, a transmitter 1015, and a communications manager 1020. The communications manager 1020 can be implemented, at least in part, by one or both of a modem and a processor. Each of these components may be in communication with one another (for example, via one or more buses).

The receiver 1010 may provide a means for receiving information such as packets, user data, control information, or any combination thereof associated with various information channels (for example, control channels, data channels, information channels related to EDT adjustment based on sensing and transmission beams). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (for example, control channels, data channels, information channels related to EDT adjustment based on sensing and transmission beams). In some examples, the transmitter 1015 may be co-located with a receiver 1010 in a transceiver. The transmitter 1015 may utilize a single antenna or a set of multiple antennas.

The communications manager 1020, the receiver 1010, the transmitter 1015, or various combinations thereof or various components thereof may be examples of means for performing various aspects of EDT adjustment based on sensing and transmission beams. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (for example, in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (for example, by executing, by the processor, instructions stored in the memory).

Additionally or alternatively, in some examples, the communications manager 1020, the receiver 1010, the transmitter 1015, or various combinations or components thereof may be implemented in code (for example, as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a central processing unit (CPU), an ASIC, an FPGA, or any combination of these or other programmable logic devices (for example, configured as or otherwise supporting a means for performing the functions described in the present disclosure).

In some examples, the communications manager 1020 may be configured to perform various operations (for example, receiving, monitoring, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to receive information, transmit information, or perform various other operations.

The communications manager 1020 may support wireless communication at the device 1005 in accordance with examples as disclosed herein. For example, the communications manager 1020 may be configured as or otherwise support a means for receiving control signaling indicating a beam configuration. The communications manager 1020 may be configured as or otherwise support a means for selecting a first beam for wireless communication based on the beam configuration, the first beam being associated with a first pointing direction. The communications manager 1020 may be configured as or otherwise support a means for selecting a second beam based on the beam configuration, the second beam being associated with a second pointing direction. The communications manager 1020 may be configured as or otherwise support a means for determining an EDT associated with the second beam based on a first beam gain of the first beam in the first pointing direction and a second beam gain of the second beam in the first pointing direction. The communications manager 1020 may be configured as or otherwise support a means for sensing a channel using the second beam based on the EDT associated with the second beam.

Additionally or alternatively, the communications manager 1020 may support wireless communication at the device 1005 in accordance with examples as disclosed herein. For example, the communications manager 1020 may be configured as or otherwise support a means for receiving control signaling indicating a beam configuration. The communications manager 1020 may be configured as or otherwise support a means for selecting a first beam for wireless communication based on the beam configuration, the first beam being associated with a first pointing direction. The communications manager 1020 may be configured as or otherwise support a means for selecting a second beam based on the beam configuration, the second beam being associated with a second pointing direction. The communications manager 1020 may be configured as or otherwise support a means for determining an EDT associated with the second beam based on a second beam gain of the second beam in the second pointing direction and a first beam gain of the first beam in the first pointing direction. The communications manager 1020 may be configured as or otherwise support a means for sensing a channel using the second beam based on the EDT associated with the second beam.

By including or configuring the communications manager 1020 in to support EDT adjustment, the device 1005 (for example, a processor controlling or otherwise coupled to the receiver 1010, the transmitter 1015, the communications manager 1020, or a combination thereof may support techniques for reduced power consumption.

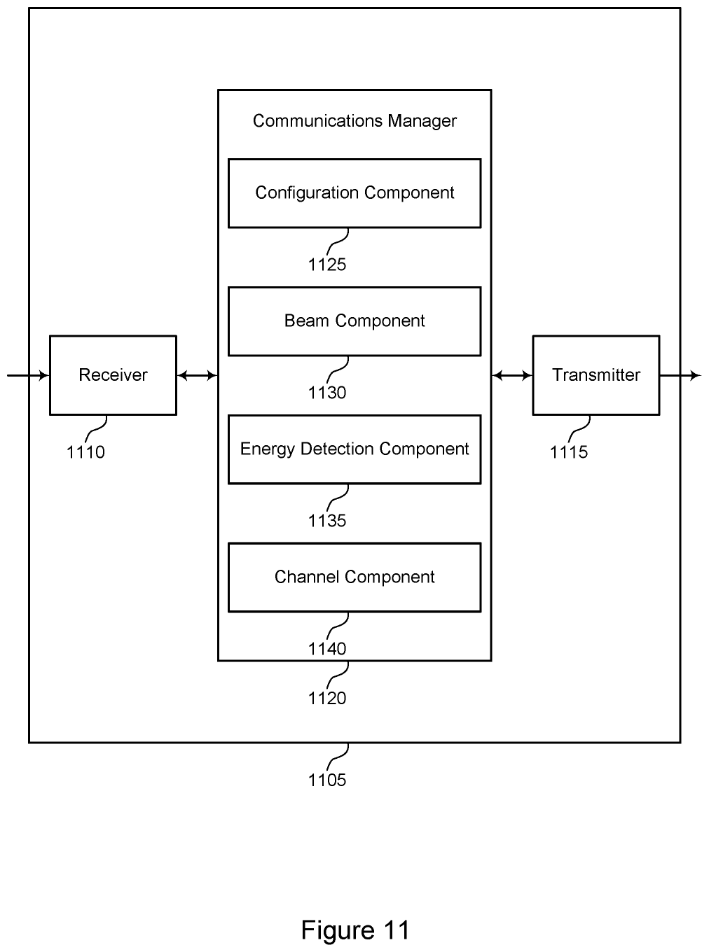

FIG. 11 shows a block diagram of a device 1105 that supports EDT adjustment based on sensing and transmission beams in accordance with aspects of the present disclosure. The device 1105 may be an example of aspects of a device 1005 or one or more of a base station 105 or a UE 115. The device 1105 may include a receiver 1110, a transmitter 1115, and a communications manager 1120. The communications manager 1120 can be implemented, at least in part, by one or both of a modem and a processor. Each of these components may be in communication with one another (for example, via one or more buses).

The receiver 1110 may provide a means for receiving information such as packets, user data, control information, or any combination thereof associated with various information channels (for example, control channels, data channels, information channels related to EDT adjustment based on sensing and transmission beams). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (for example, control channels, data channels, information channels related to EDT adjustment based on sensing and transmission beams). In some examples, the transmitter 1115 may be co-located with a receiver 1110 in a transceiver. The transmitter 1115 may utilize a single antenna or a set of multiple antennas.

The device 1105, or various components thereof, may be an example of means for performing various aspects of EDT adjustment based on sensing and transmission beams. For example, the communications manager 1120 may include a configuration component 1125, a beam component 1130, an energy detection component 1135, a channel component 1140, or any combination thereof. In some examples, the communications manager 1120, or various components thereof, may be configured to perform various operations (for example, receiving, monitoring, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to receive information, transmit information, or perform various other operations.

The communications manager 1120 may support wireless communication at the device 1105 in accordance with examples as disclosed herein. The configuration component 1125 may be configured as or otherwise support a means for receiving control signaling indicating a beam configuration. The beam component 1130 may be configured as or otherwise support a means for selecting a first beam for wireless communication based on the beam configuration, the first beam being associated with a first pointing direction. The beam component 1130 may be configured as or otherwise support a means for selecting a second beam based on the beam configuration, the second beam being associated with a second pointing direction. The energy detection component 1135 may be configured as or otherwise support a means for determining an EDT associated with the second beam based on a first beam gain of the first beam in the first pointing direction and a second beam gain of the second beam in the first pointing direction. The channel component 1140 may be configured as or otherwise support a means for sensing a channel using the second beam based on the EDT associated with the second beam.

Additionally or alternatively, the communications manager 1120 may support wireless communication at the device 1105 in accordance with examples as disclosed herein. The configuration component 1125 may be configured as or otherwise support a means for receiving control signaling indicating a beam configuration. The beam component 1130 may be configured as or otherwise support a means for selecting a first beam for wireless communication based on the beam configuration, the first beam being associated with a first pointing direction. The beam component 1130 may be configured as or otherwise support a means for selecting a second beam based on the beam configuration, the second beam being associated with a second pointing direction. The energy detection component 1135 may be configured as or otherwise support a means for determining an EDT associated with the second beam based on a second beam gain of the second beam in the second pointing direction and a first beam gain of the first beam in the first pointing direction. The channel component 1140 may be configured as or otherwise support a means for sensing a channel using the second beam based on the EDT associated with the second beam.

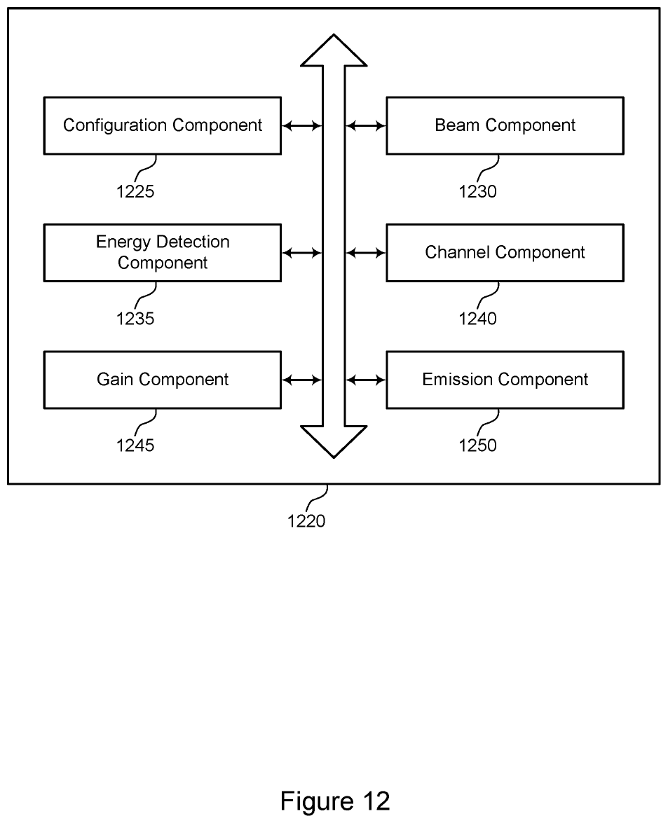

FIG. 12 shows a block diagram of a communications manager 1220 that supports EDT adjustment based on sensing and transmission beams in accordance with aspects of the present disclosure. The communications manager 1220, or various components thereof, may be an example of means for performing various aspects of EDT adjustment based on sensing and transmission beams. For example, the communications manager 1220 may include a configuration component 1225, a beam component 1230, an energy detection component 1235, a channel component 1240, a gain component 1245, a pointing component 1250, or any combination thereof. Each of these components may communicate, directly or indirectly, with one another (for example, via one or more buses).

The communications manager 1220 may support wireless communication at a device in accordance with examples as disclosed herein. The configuration component 1225 may be configured as or otherwise support a means for receiving control signaling indicating a beam configuration. The beam component 1230 may be configured as or otherwise support a means for selecting a first beam for wireless communication based on the beam configuration, the first beam being associated with a first pointing direction. In some examples, the beam component 1230 may be configured as or otherwise support a means for selecting a second beam based on the beam configuration, the second beam being associated with a second pointing direction. The energy detection component 1235 may be configured as or otherwise support a means for determining an EDT associated with the second beam based on a first beam gain of the first beam in the first pointing direction and a second beam gain of the second beam in the first pointing direction. The channel component 1240 may be configured as or otherwise support a means for sensing a channel using the second beam based on the EDT associated with the second beam.

In some examples, the energy detection component 1235 may be configured as or otherwise support a means for determining a baseline EDT based on the beam configuration. In some examples, the energy detection component 1235 may be configured as or otherwise support a means for determining the EDT based on the baseline EDT. In some examples, the gain component 1245 may be configured as or otherwise support a means for determining a gain delta value based on a difference between the second beam gain of the second beam in the first pointing direction and the first beam gain of the first beam in the first pointing direction. In some examples, the energy detection component 1235 may be configured as or otherwise support a means for determining the EDT based on one or more of the baseline EDT or the gain delta value.

In some examples, the gain component 1245 may be configured as or otherwise support a means for determining a correction value between a null value and the gain delta value based on a function. In some examples, the energy detection component 1235 may be configured as or otherwise support a means for determining the EDT based on the correction value. In some examples, to support determining the correction value, the gain component 1245 may be configured as or otherwise support a means for determining a local minima value of the function, the function including a minima function. In some examples, to support determining the correction value, the energy detection component 1235 may be configured as or otherwise support a means for determining the EDT based on the local minima value. In some examples, the function is based on a first input and a second input, the first input including the null value and the second input including a second function. In some examples, determining the gain delta value is based on the second function, the second function including a logarithmic function. In some examples, the logarithmic function is based on a third input and a fourth input, the third input including the first beam gain of the first beam in the first pointing direction and the fourth input including the second beam gain of the second beam in the first pointing direction.

In some examples, the gain component 1245 may be configured as or otherwise support a means for determining that the first beam gain of the first beam in the first pointing direction is greater than the second beam gain of the second beam in the first pointing direction. In some examples, the energy detection component 1235 may be configured as or otherwise support a means for determining the EDT based on determining that the first beam gain of the first beam in the first pointing direction is greater than the second beam gain of the second beam in the first pointing direction. In some examples, the beam component 1230 may be configured as or otherwise support a means for selecting a third beam for wireless communication based on the beam configuration, the third beam including a third beam gain and being associated with a third pointing direction, the first beam and the third beam associated with a set of beams for wireless communication. In some examples, the energy detection component 1235 may be configured as or otherwise support a means for determining the EDT based on the first beam, the second beam, and the third beam. In some examples, the energy detection component 1235 may be configured as or otherwise support a means for determining a baseline EDT according to a first function and based on one or more of the first beam in the first pointing direction or the third beam in the third pointing direction. In some examples, the energy detection component 1235 may be configured as or otherwise support a means for determining the EDT based on the baseline EDT.

In some examples, the energy detection component 1235 may be configured as or otherwise support a means for determining a local minima value of the first function, the first function including a first minima function, the local minima value corresponding to the baseline EDT. In some examples, the energy detection component 1235 may be configured as or otherwise support a means for determining the EDT based on the local minima value. In some examples, the gain component 1245 may be configured as or otherwise support a means for determining a gain delta value based on one or more of a first difference between the second beam gain of the second beam in the first pointing direction and the first beam gain of the first beam in the first pointing direction, or a second difference between the second beam gain of the second beam in the third pointing direction and the third beam gain of the third beam in the third pointing direction. In some examples, the energy detection component 1235 may be configured as or otherwise support a means for determining the EDT based on one or more of the baseline EDT or the gain delta value.

In some examples, the gain component 1245 may be configured as or otherwise support a means for determining a correction value between a null value and the gain delta value according to a second function, the correction value corresponding to a gain ratio associated with one or more of the first beam gain of the first beam, the second beam gain of the second beam, or the third beam gain of the third beam. In some examples, the energy detection component 1235 may be configured as or otherwise support a means for determining the EDT based on the correction value. In some examples, to support determining the correction value, the gain component 1245 may be configured as or otherwise support a means for determining a local minima value of the second function, the second function including a second minima function. In some examples, to support determining the correction value, the energy detection component 1235 may be configured as or otherwise support a means for determining the EDT based on the local minima value. In some examples, determining the correction value for the EDT according to one or more of the first function or the second function is based on a single beam angle associated with at least one of the first beam, the second beam, or the third beam.

In some examples, the gain component 1245 may be configured as or otherwise support a means for determining a correction value between a baseline EDT and a gain delta value based on a function, the baseline EDT is based on one or more of the first beam, the second beam, or the third beam, the gain delta value is based on one or more of a first difference between the second beam gain of the second beam in the first pointing direction and the first beam gain of the first beam in the first pointing direction, or a second difference between the second beam gain of the second beam in the third pointing direction and the third beam gain of the third beam in the third pointing direction. In some examples, the energy detection component 1235 may be configured as or otherwise support a means for determining the EDT is based on the correction value. In some examples, to support determining the correction value, the gain component 1245 may be configured as or otherwise support a means for determining a local minima value of the function based on the baseline EDT and the gain delta value, the function including a minima function. In some examples, to support determining the correction value, the energy detection component 1235 may be configured as or otherwise support a means for determining the EDT based on the local minima value.

In some examples, determining the correction value for the EDT according to the function is based on a single beam angle associated with at least one of the first beam, the second beam, or the third beam. In some examples, determining a correction value for the EDT is based on a subset of an angle. In some examples, determining a correction value associated with the EDT is based on an index of at least one angle corresponding to at least one of the first pointing direction associated with the first beam or the third pointing direction associated with the third beam. In some examples, a beam angle associated with the first beam is within a threshold of a beam angle associated with the second beam. In some examples, determining the EDT is based on a threshold difference between the first pointing direction associated with the first beam and the second pointing direction associated with the second beam. In some examples, the first beam includes a transmitting beam and the second beam includes a sensing beam.

Additionally or alternatively, the communications manager 1220 may support wireless communication at a device in accordance with examples as disclosed herein. In some examples, the configuration component 1225 may be configured as or otherwise support a means for receiving control signaling indicating a beam configuration. In some examples, the beam component 1230 may be configured as or otherwise support a means for selecting a first beam for wireless communication based on the beam configuration, the first beam being associated with a first pointing direction. In some examples, the beam component 1230 may be configured as or otherwise support a means for selecting a second beam based on the beam configuration, the second beam being associated with a second pointing direction. In some examples, the energy detection component 1235 may be configured as or otherwise support a means for determining an EDT associated with the second beam based on a second beam gain of the second beam in the second pointing direction and a first beam gain of the first beam in the first pointing direction. In some examples, the channel component 1240 may be configured as or otherwise support a means for sensing a channel using the second beam based on the EDT associated with the second beam.

In some examples, the pointing component 1250 may be configured as or otherwise support a means for determining that the first pointing direction associated with the first beam and the second pointing direction associated with the second beam satisfy a threshold. In some examples, the energy detection component 1235 may be configured as or otherwise support a means for determining the EDT based on determining that the first pointing direction associated with the first beam and the second pointing direction associated with the second beam satisfy the threshold. In some examples, the energy detection component 1235 may be configured as or otherwise support a means for determining a baseline EDT based on the beam configuration. In some examples, the energy detection component 1235 may be configured as or otherwise support a means for determining the EDT based on the baseline EDT.

In some examples, the gain component 1245 may be configured as or otherwise support a means for determining a gain delta value based on a difference between the second beam gain of the second beam in the second pointing direction and the first beam gain of the first beam in the first pointing direction. In some examples, the energy detection component 1235 may be configured as or otherwise support a means for determining the EDT based on one or more of the baseline EDT or the gain delta value. In some examples, the gain component 1245 may be configured as or otherwise support a means for determining a correction value between a null value and the gain delta value based on a function. In some examples, the energy detection component 1235 may be configured as or otherwise support a means for determining the EDT based on the correction value. In some examples, to support determining the correction value, the gain component 1245 may be configured as or otherwise support a means for determining a local minima value of the function, the function including a minima function. In some examples, to support determining the correction value, the energy detection component 1235 may be configured as or otherwise support a means for determining the EDT based on the local minima value.

In some examples, the function is based on a first input and a second input, the first input including the null value and the second input including a second function. In some examples, determining the gain delta value is based on the second function, the second function including a logarithmic function. In some examples, the logarithmic function is based on a third input and a fourth input, the third input including the first beam gain of the first beam in the first pointing direction and the fourth input including the second beam gain of the second beam in the second pointing direction. In some examples, the gain component 1245 may be configured as or otherwise support a means for determining that the first beam gain of the first beam in the first pointing direction is greater than the second beam gain of the second beam in the second pointing direction. In some examples, the energy detection component 1235 may be configured as or otherwise support a means for in which determining the EDT is based on determining that the first beam gain of the first beam in the first pointing direction is greater than the second beam gain of the second beam in the second pointing direction.

In some examples, the beam component 1230 may be configured as or otherwise support a means for selecting a third beam for wireless communication based on the beam configuration, the third beam including a third beam gain and being associated with a third pointing direction. In some examples, the energy detection component 1235 may be configured as or otherwise support a means for determining the EDT based on the third beam. In some examples, the energy detection component 1235 may be configured as or otherwise support a means for determining a baseline EDT associated with one or more of the first beam in the first pointing direction or the third beam in the third pointing direction based on a function. In some examples, the energy detection component 1235 may be configured as or otherwise support a means for determining the EDT based on the baseline EDT. In some examples, the energy detection component 1235 may be configured as or otherwise support a means for determining a local minima value of the function, the function including a minima function, the local minima value corresponding to the baseline EDT. In some examples, the energy detection component 1235 may be configured as or otherwise support a means for determining the EDT based on the local minima value.

In some examples, the gain component 1245 may be configured as or otherwise support a means for determining a gain delta value based on one or more of a first difference between the second beam gain of the second beam in the second pointing direction and the first beam gain of the first beam in the first pointing direction, or a second difference between the second beam gain of the second beam in the second pointing direction and the third beam gain of the third beam in the third pointing direction. In some examples, the energy detection component 1235 may be configured as or otherwise support a means for determining the EDT based on one or more of the baseline EDT or the gain delta value.

In some examples, the gain component 1245 may be configured as or otherwise support a means for determining a correction value between a null value and the gain delta value based on the function, the correction value corresponding to a gain ratio associated with one or more of the first beam gain, the second beam gain, or the third beam gain. In some examples, the energy detection component 1235 may be configured as or otherwise support a means for determining the EDT based on determining the correction value. In some examples, to support determining the correction value, the gain component 1245 may be configured as or otherwise support a means for determining a local minima value of the function, the function including a minima function. In some examples, to support determining the correction value, the energy detection component 1235 may be configured as or otherwise support a means for determining the EDT based on the local minima value. In some examples, determining the correction value is based on the gain ratio associated with at least two angles.

In some examples, the gain component 1245 may be configured as or otherwise support a means for determining a correction value between a baseline EDT and a gain delta value based on a function, the baseline EDT is based on one or more of the first beam, the second beam, or the third beam, the gain delta value is based on one or more of a first difference between the second beam gain of the second beam in the first pointing direction and the first beam gain of the first beam in the first pointing direction, or a second difference between the second beam gain of the second beam in the third pointing direction and the third beam gain of the third beam in the third pointing direction. In some examples, the energy detection component 1235 may be configured as or otherwise support a means for determining the EDT based on the correction value.

In some examples, to support determining the correction value, the gain component 1245 may be configured as or otherwise support a means for determining a local minima value of the function based on the baseline EDT and the gain delta value, the function including a minima function. In some examples, to support determining the correction value, the energy detection component 1235 may be configured as or otherwise support a means for determining the EDT based on the local minima value of the function.

In some examples, determining the correction value for the EDT according to the function is based on a subset of at least two angles. In some examples, determining a correction value for the EDT is based on a subset of an angle corresponding to one or more of the first pointing direction associated with the first beam, the second pointing direction associated with the second beam, or the third pointing direction associated with the third beam. In some examples, determining a correction value associated with the EDT is based on an index of at least two beam angles corresponding to one or more of the first pointing direction associated with the first beam or the third pointing direction associated with the third beam. In some examples, the first beam includes a transmitting beam and the second beam includes a sensing beam.

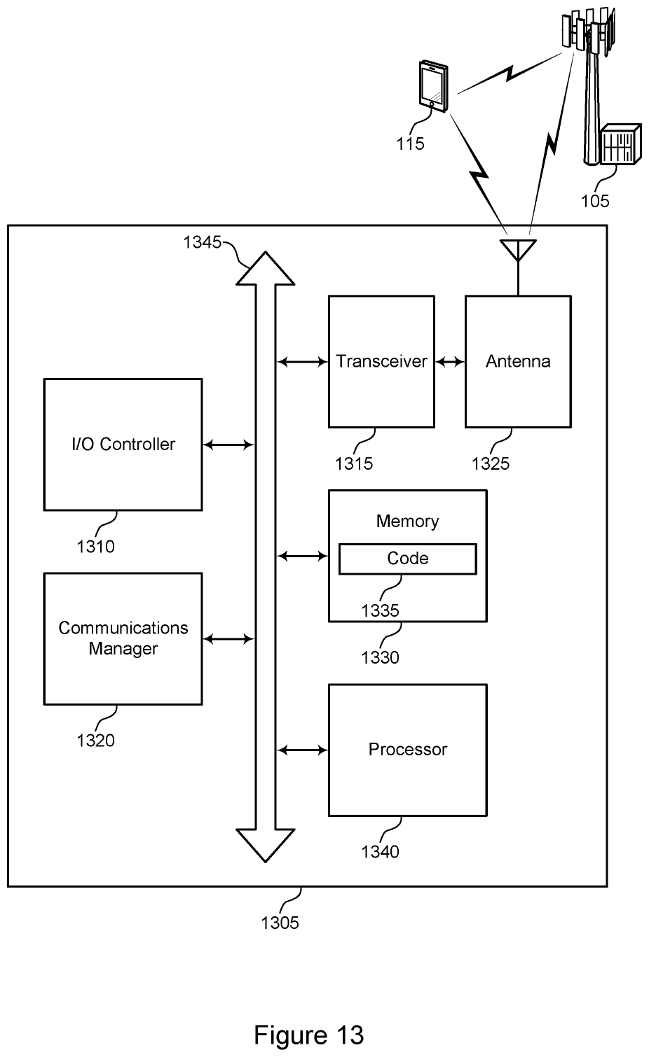

FIG. 13 shows a diagram of a system including a device 1305 that supports EDT adjustment based on sensing and transmission beams in accordance with aspects of the present disclosure. The device 1305 may be an example of or include the components of a device 1005, a device 1105, or one or more of a base station 105 or a UE 115. The device 1305 may communicate wirelessly with one or more base stations 105, UEs 115, or any combination thereof. The device 1305 may include components for bi-directional voice and data communications including components for transmitting and receiving communications, such as a communications manager 1320, an input/output (I/O) controller 1310, a transceiver 1315, an antenna 1325, a memory 1330, code 1335, and a processor 1340. These components may be in electronic communication or otherwise coupled (for example, operatively, communicatively, functionally, electronically, electrically) via one or more buses (for example, a bus 1345).

The I/O controller 1310 may manage input and output signals for the device 1305. The I/O controller 1310 may also manage peripherals not integrated into the device 1305. In some examples, the I/O controller 1310 may represent a physical connection or port to an external peripheral. In some examples, the I/O controller 1310 may utilize an operating system such as iOS®, ANDROID®, MS-DOS®, MS-WINDOWS®, OS/2®, UNIX®, LINUX®, or another known operating system. Additionally or alternatively, the I/O controller 1310 may represent or interact with a modem, a keyboard, a mouse, a touchscreen, or a similar device. In some examples, the I/O controller 1310 may be implemented as part of a processor, such as the processor 1340. In some examples, a user may interact with the device 1305 via the I/O controller 1310 or via hardware components controlled by the I/O controller 1310.

In some examples, the device 1305 may include a single antenna 1325. However, in some other cases, the device 1305 may have more than one antenna 1325, which may be capable of concurrently transmitting or receiving multiple wireless transmissions. The transceiver 1315 may communicate bi-directionally, via the one or more antennas 1325, wired, or wireless links. For example, the transceiver 1315 may represent a wireless transceiver and may communicate bi-directionally with another wireless transceiver. The transceiver 1315 may also include a modem to modulate the packets, to provide the modulated packets to one or more antennas 1325 for transmission, and to demodulate packets received from the one or more antennas 1325. The transceiver 1315, or the transceiver 1315 and one or more antennas 1325, may be an example of a transmitter 1015, a transmitter 1115, a receiver 1010, a receiver 1110, or any combination thereof or component thereof.

The memory 1330 may include random access memory (RAM) and read-only memory (ROM). The memory 1330 may store computer-readable, computer-executable code 1335 including instructions that, if executed by the processor 1340, cause the device 1305 to perform various functions described herein. The code 1335 may be stored in a non-transitory computer-readable medium such as system memory or another type of memory. In some examples, the code 1335 may not be directly executable by the processor 1340 but may cause a computer (for example, if compiled and executed) to perform functions described herein. In some examples, the memory 1330 may contain, among other things, a basic I/O system (BIOS), which may control basic hardware or software operation such as the interaction with peripheral components or devices.

The processor 1340 may include an intelligent hardware device (for example, a general-purpose processor, a DSP, a CPU, a microcontroller, an ASIC, an FPGA, a programmable logic device, a discrete gate or transistor logic component, a discrete hardware component, or any combination thereof). In some examples, the processor 1340 may be configured to operate a memory array using a memory controller. In some other cases, a memory controller may be integrated into the processor 1340. The processor 1340 may be configured to execute computer-readable instructions stored in a memory (for example, the memory 1330) to cause the device 1305 to perform various functions (for example, functions or tasks supporting EDT adjustment based on sensing and transmission beams). For example, the device 1305 or a component of the device 1305 may include a processor 1340 and memory 1330 coupled to the processor 1340, the processor 1340 and memory 1330 configured to perform various functions described herein.

The communications manager 1320 may support wireless communication at the device 1305 in accordance with examples as disclosed herein. For example, the communications manager 1320 may be configured as or otherwise support a means for receiving control signaling indicating a beam configuration. The communications manager 1320 may be configured as or otherwise support a means for selecting a first beam for wireless communication based on the beam configuration, the first beam being associated with a first pointing direction. The communications manager 1320 may be configured as or otherwise support a means for selecting a second beam based on the beam configuration, the second beam being associated with a second pointing direction. The communications manager 1320 may be configured as or otherwise support a means for determining an EDT associated with the second beam based on a first beam gain of the first beam in the first pointing direction and a second beam gain of the second beam in the first pointing direction. The communications manager 1320 may be configured as or otherwise support a means for sensing a channel using the second beam based on the EDT associated with the second beam.

Additionally or alternatively, the communications manager 1320 may support wireless communication at the device 1305 in accordance with examples as disclosed herein. For example, the communications manager 1320 may be configured as or otherwise support a means for receiving control signaling indicating a beam configuration. The communications manager 1320 may be configured as or otherwise support a means for selecting a first beam for wireless communication based on the beam configuration, the first beam being associated with a first pointing direction. The communications manager 1320 may be configured as or otherwise support a means for selecting a second beam based on the beam configuration, the second beam being associated with a second pointing direction. The communications manager 1320 may be configured as or otherwise support a means for determining an EDT associated with the second beam based on a second beam gain of the second beam in the second pointing direction and a first beam gain of the first beam in the first pointing direction. The communications manager 1320 may be configured as or otherwise support a means for sensing a channel using the second beam based on the EDT associated with the second beam. By including or configuring the communications manager 1320 to support EDT adjustment, the device 1305 may support techniques for improved communication reliability.

In some examples, the communications manager 1320 may be configured to perform various operations (for example, receiving, monitoring, transmitting) using or otherwise in cooperation with the transceiver 1315, the one or more antennas 1325, or any combination thereof. Although the communications manager 1320 is illustrated as a separate component, in some examples, one or more functions described with reference to the communications manager 1320 may be supported by or performed by the processor 1340, the memory 1330, the code 1335, or any combination thereof. For example, the code 1335 may include instructions executable by the processor 1340 to cause the device 1305 to perform various aspects of EDT adjustment based on sensing and transmission beams, or the processor 1340 and the memory 1330 may be otherwise configured to perform or support such operations.

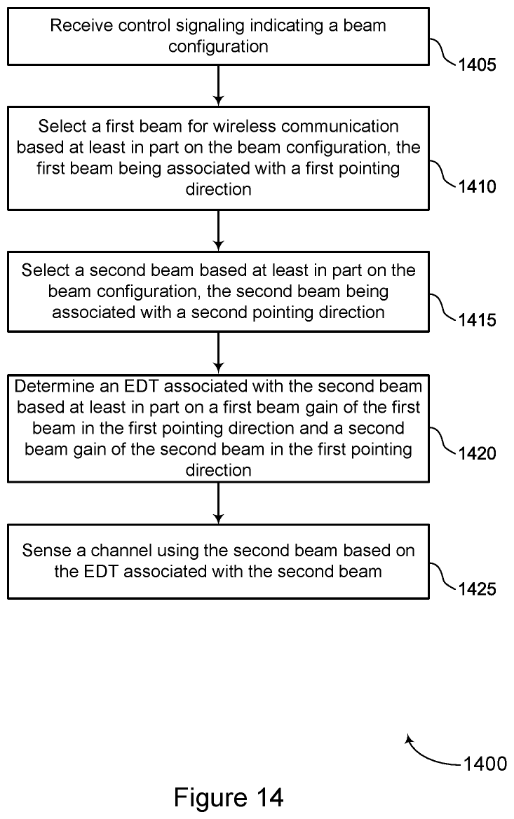

FIG. 14 shows a flowchart illustrating a method 1400 that supports energy detection threshold adjustment based on sensing and transmission beams in accordance with aspects of the present disclosure. The operations of the method 1400 may be implemented by a UE or its components. For example, the operations of the method 1400 may be performed by a UE 115 as described with reference to FIGS. 1-13. In some examples, a UE may execute a set of instructions to control the functional elements of the UE to perform the described functions. Additionally or alternatively, the UE may perform aspects of the described functions using special-purpose hardware.

At 1405, the method may include receiving control signaling indicating a beam configuration. The operations of 1405 may be performed in accordance with examples as disclosed herein. In some examples, aspects of the operations of 1405 may be performed by a configuration component 1225 as described with reference to FIG. 12.

At 1410, the method may include selecting a first beam for wireless communication based on the beam configuration, the first beam including a first beam gain and a first pointing direction. The operations of 1410 may be performed in accordance with examples as disclosed herein. In some examples, aspects of the operations of 1410 may be performed by a beam component 1230 as described with reference to FIG. 12.

At 1415, the method may include selecting a second beam based on the beam configuration, the second beam including a second beam gain and a second pointing direction. The operations of 1415 may be performed in accordance with examples as disclosed herein. In some examples, aspects of the operations of 1415 may be performed by a beam component 1230 as described with reference to FIG. 12.

At 1420, the method may include determining an EDT associated with the second beam based on the second beam gain in the first pointing direction and the first beam gain in the first pointing direction. The operations of 1420 may be performed in accordance with examples as disclosed herein. In some examples, aspects of the operations of 1420 may be performed by an energy detection component 1235 as described with reference to FIG. 12.

At 1425, the method may include sensing a channel using the second beam and the EDT associated with the second beam. The operations of 1425 may be performed in accordance with examples as disclosed herein. In some examples, aspects of the operations of 1425 may be performed by a channel component 1240 as described with reference to FIG. 12.

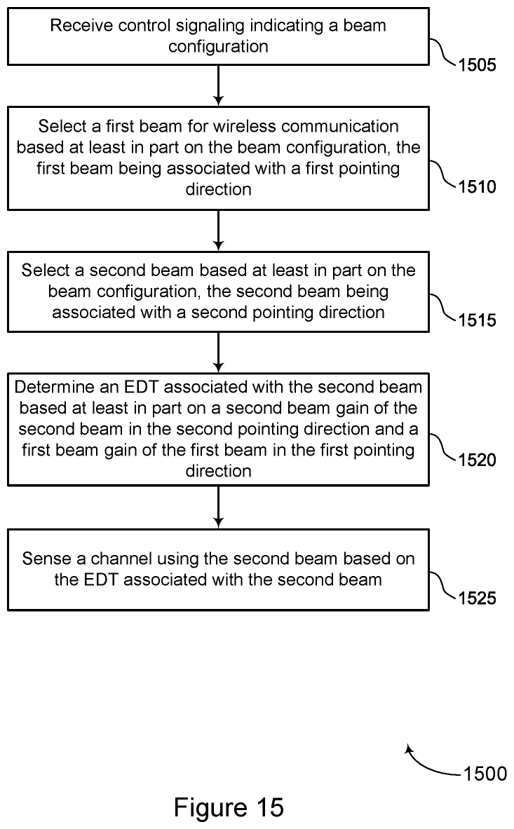

FIG. 15 shows a flowchart illustrating a method 1500 that supports EDT adjustment based on sensing and transmission beams in accordance with aspects of the present disclosure. The operations of the method 1500 may be implemented by a UE or its components. For example, the operations of the method 1500 may be performed by a UE 115 as described with reference to FIGS. 1-13. In some examples, a UE may execute a set of instructions to control the functional elements of the UE to perform the described functions. Additionally or alternatively, the UE may perform aspects of the described functions using special-purpose hardware.

At 1505, the method may include receiving control signaling indicating a beam configuration. The operations of 1505 may be performed in accordance with examples as disclosed herein. In some examples, aspects of the operations of 1505 may be performed by a configuration component 1225 as described with reference to FIG. 12.

At 1510, the method may include selecting a first beam for wireless communication based on the beam configuration, the first beam including a first beam gain and a first pointing direction. The operations of 1510 may be performed in accordance with examples as disclosed herein. In some examples, aspects of the operations of 1510 may be performed by a beam component 1230 as described with reference to FIG. 12.

At 1515, the method may include selecting a second beam based on the beam configuration, the second beam including a second beam gain and a second pointing direction. The operations of 1515 may be performed in accordance with examples as disclosed herein. In some examples, aspects of the operations of 1515 may be performed by a beam component 1230 as described with reference to FIG. 12.

At 1520, the method may include determining an EDT associated with the second beam based on the second beam gain in the second pointing direction and the first beam gain in the first pointing direction. The operations of 1520 may be performed in accordance with examples as disclosed herein. In some examples, aspects of the operations of 1520 may be performed by an energy detection component 1235 as described with reference to FIG. 12.

At 1525, the method may include sensing a channel using the second beam and the EDT associated with the second beam. The operations of 1525 may be performed in accordance with examples as disclosed herein. In some examples, aspects of the operations of 1525 may be performed by a channel component 1240 as described with reference to FIG. 12.

The following provides an overview of aspects of the present disclosure:

Aspect 1: A method for wireless communication at a device, comprising: receiving control signaling indicating a beam configuration; selecting a first beam for wireless communication based at least in part on the beam configuration, the first beam being associated with a first pointing direction; selecting a second beam based at least in part on the beam configuration, the second beam being associated with a second pointing direction; determining an EDT associated with the second beam based at least in part on a first beam gain of the first beam in the first pointing direction and a second beam gain of the second beam in the first pointing direction; and sensing a channel using the second beam based at least in part on the EDT associated with the second beam.

Aspect 2: The method of aspect 1, further comprising determining a baseline EDT based at least in part on the beam configuration, wherein determining the EDT is based at least in part on the baseline EDT.

Aspect 3: The method of aspect 2, further comprising determining a gain delta value based at least in part on a difference between the second beam gain of the second beam in the first pointing direction and the first beam gain of the first beam in the first pointing direction, wherein determining the EDT is based at least in part on one or more of the baseline EDT or the gain delta value.

Aspect 4: The method of aspect 3, further comprising determining a correction value between a null value and the gain delta value based at least in part on a function, wherein determining the EDT is based at least in part on the correction value.

Aspect 5: The method of aspect 4, wherein determining the correction value comprises determining a local minima value of the function, the function comprising a minima function, determining the EDT is based at least in part on the local minima value.

Aspect 6: The method of any of aspects 4 through 5, wherein the function is based at least in part on a first input and a second input, the first input comprising the null value and the second input comprising a second function.

Aspect 7: The method of aspect 6, wherein determining the gain delta value is based at least in part on the second function, the second function comprising a logarithmic function.

Aspect 8: The method of aspect 7, wherein the logarithmic function is based at least in part on a third input and a fourth input, the third input comprising the first beam gain of the first beam in the first pointing direction and the fourth input comprising the second beam gain of the second beam in the first pointing direction.

Aspect 9: The method of any of aspects 1 through 8, further comprising determining that the first beam gain of the first beam in the first pointing direction is greater than the second beam gain of the second beam in the first pointing direction, wherein determining the EDT is based at least in part on determining that the first beam gain of the first beam in the first pointing direction is greater than the second beam gain of the second beam in the first pointing direction.

Aspect 10: The method of any of aspects 1 through 9, further comprising selecting a third beam for wireless communication based at least in part on the beam configuration, the third beam comprising a third beam gain and being associated with a third pointing direction, the first beam and the third beam associated with a set of beams for wireless communication, wherein determining the EDT is based at least in part on the first beam in the first pointing direction, the second beam in the first pointing direction, and the third beam in the third pointing direction.

Aspect 11: The method of aspect 10, further comprising determining a baseline EDT according to a first function and based at least in part on one or more of the first beam in the first pointing direction or the third beam in the third pointing direction, wherein determining the EDT is based at least in part on the baseline EDT.

Aspect 12: The method of aspect 11, further comprising determining a local minima value of the first function, the first function comprising a first minima function, the local minima value corresponding to the baseline EDT, wherein determining the EDT is based at least in part on the local minima value.

Aspect 13: The method of any of aspects 11 through 12, further comprising determining a gain delta value based at least in part on one or more of a first difference between the second beam gain of the second beam in the first pointing direction and the first beam gain of the first beam in the first pointing direction, or a second difference between the second beam gain of the second beam in the third pointing direction and the third beam gain of the third beam in the third pointing direction, wherein determining the EDT is based at least in part on one or more of the baseline EDT or the gain delta value.

Aspect 14: The method of aspect 13, further comprising determining a correction value between a null value and the gain delta value according to a second function, the correction value corresponding to a gain ratio associated with two or more of the first beam gain of the first beam, the second beam gain of the second beam, or the third beam gain of the third beam, wherein determining the EDT is based at least in part on the correction value.

Aspect 15: The method of aspect 14, wherein determining the correction value comprises determining a local minima value of the second function, the second function comprising a second minima function, determining the EDT is based at least in part on the local minima value.

Aspect 16: The method of any of aspects 14 through 15, wherein determining the correction value for the EDT according to one or more of the first function or the second function is based at least in part on a single beam angle associated with at least one of the first beam, the second beam, or the third beam.

Aspect 17: The method of any of aspects 10 through 16, further comprising determining a correction value between a baseline EDT and a gain delta value based at least in part on a function, the baseline EDT is based at least in part on one or more of the first beam, the second beam, or the third beam, the gain delta value is based at least in part on one or more of a first difference between the second beam gain of the second beam in the first pointing direction and the first beam gain of the first beam in the first pointing direction, or a second difference between the second beam gain of the second beam in the third pointing direction and the third beam gain of the third beam in the third pointing direction, wherein determining the EDT is based at least in part on the correction value.

Aspect 18: The method of aspect 17, wherein determining the correction value comprises determining a local minima value of the function based at least in part on the baseline EDT and the gain delta value, the function comprising a minima function, determining the EDT is based at least in part on the local minima value.

Aspect 19: The method of any of aspects 17 through 18, wherein determining the correction value for the EDT according to the function is based at least in part on a single beam angle associated with at least one of the first beam, the second beam, or the third beam.

Aspect 20: The method of any of aspects 10 through 19, wherein determining a correction value for the EDT is based at least in part on a subset of an angle.

Aspect 21: The method of any of aspects 10 through 20, wherein determining a correction value associated with the EDT is based at least in part on an index of at least one angle corresponding to at least one of the first pointing direction associated with the first beam or the third pointing direction associated with the third beam.

Aspect 22: The method of any of aspects 1 through 21, wherein a beam angle associated with the first beam is within a threshold of a beam angle associated with the second beam.

Aspect 23: The method of any of aspects 1 through 22, wherein determining the EDT is based at least in part on a threshold difference between the first pointing direction associated with the first beam and the second pointing direction associated with the second beam.

Aspect 24: The method of any of aspects 1 through 23, wherein the first beam comprises a transmitting beam and the second beam comprises a sensing beam.

Aspect 25: A method for wireless communication at a device, comprising: receiving control signaling indicating a beam configuration; selecting a first beam for wireless communication based at least in part on the beam configuration, the first beam being associated with a first pointing direction; selecting a second beam based at least in part on the beam configuration, the second beam being associated with a second pointing direction; determining an EDT associated with the second beam based at least in part on a second beam gain of the second beam in the second pointing direction and a first beam gain of the first beam in the first pointing direction; and sensing a channel using the second beam based at least in part on the EDT associated with the second beam.

Aspect 26: The method of aspect 25, further comprising determining that the first pointing direction associated with the first beam and the second pointing direction associated with the second beam satisfy a threshold, wherein determining the EDT is based at least in part on determining that the first pointing direction associated with the first beam and the second pointing direction associated with the second beam satisfy the threshold.

Aspect 27: The method of any of aspects 25 through 26, further comprising determining a baseline EDT based at least in part on the beam configuration, wherein determining the EDT is based at least in part on the baseline EDT.

Aspect 28: The method of aspect 27, further comprising determining a gain delta value based at least in part on a difference between the second beam gain of the second beam in the second pointing direction and the first beam gain of the first beam in the first pointing direction, wherein determining the EDT is based at least in part on one or more of the baseline EDT or the gain delta value.

Aspect 29: The method of aspect 28, further comprising determining a correction value between a null value and the gain delta value based at least in part on a function, wherein determining the EDT is based at least in part on the correction value.

Aspect 30: The method of aspect 29, wherein determining the correction value comprises determining a local minima value of the function, the function comprising a minima function, determining the EDT is based at least in part on the local minima value.

Aspect 31: The method of any of aspects 29 through 30, wherein the function is based at least in part on a first input and a second input, the first input comprising the null value and the second input comprising a second function.

Aspect 32: The method of aspect 31, wherein determining the gain delta value is based at least in part on the second function, the second function comprising a logarithmic function.

Aspect 33: The method of aspect 32, wherein the logarithmic function is based at least in part on a third input and a fourth input, the third input comprising the first beam gain of the first beam in the first pointing direction and the fourth input comprising the second beam gain of the second beam in the second pointing direction.

Aspect 34: The method of any of aspects 25 through 33, further comprising determining that the first beam gain of the first beam in the first pointing direction is greater than the second beam gain of the second beam in the second pointing direction, wherein determining the EDT is based at least in part on determining that the first beam gain of the first beam in the first pointing direction is greater than the second beam gain of the second beam in the second pointing direction.

Aspect 35: The method of any of aspects 25 through 34, further comprising selecting a third beam for wireless communication based at least in part on the beam configuration, the third beam comprising a third beam gain and being associated with a third pointing direction, the first beam and the third beam associated with a set of beams for wireless communication, wherein determining the EDT is based at least in part on the first beam, the second beam, and the third beam.

Aspect 36: The method of aspect 35, further comprising determining a baseline EDT associated with one or more of the first beam in the first pointing direction or the third beam in the third pointing direction based at least in part on a function, wherein determining the EDT is based at least in part on the baseline EDT.

Aspect 37: The method of aspect 36, further comprising determining a local minima value of the function, the function comprising a minima function, the local minima value corresponding to the baseline EDT, wherein determining the EDT is based at least in part on the local minima value.

Aspect 38: The method of any of aspects 36 through 37, further comprising determining a gain delta value based at least in part on one or more of a first difference between the second beam gain of the second beam in the second pointing direction and the first beam gain of the first beam in the first pointing direction, or a second difference between the second beam gain of the second beam in the second pointing direction and the third beam gain of the third beam in the third pointing direction, wherein determining the EDT is based at least in part on one or more of the baseline EDT or the gain delta value.

Aspect 39: The method of aspect 38, further comprising determining a correction value between a null value and the gain delta value based at least in part on the function, the correction value corresponding to a gain ratio associated with two or more of the first beam gain, the second beam gain, or the third beam gain, wherein determining the EDT is based at least in part on the correction value.

Aspect 40: The method of aspect 39, wherein determining the correction value comprises determining a local minima value of the function, the function comprising a minima function, determining the EDT is based at least in part on the local minima value.

Aspect 41: The method of any of aspects 39 through 40, wherein determining the correction value is based at least in part on the gain ratio associated with at least two angles corresponding to one or more of the first beam, the second beam, or the third beam.

Aspect 42: The method of any of aspects 35 through 41, further comprising determining a correction value between a baseline EDT and a gain delta value based at least in part on a function, the baseline EDT is based at least in part on one or more of the first beam, the second beam, or the third beam, the gain delta value is based at least in part on one or more of a first difference between the second beam gain of the second beam in the second pointing direction and the first beam gain of the first beam in the first pointing direction, or a second difference between the second beam gain of the second beam in the second pointing direction and the third beam gain of the third beam in the third pointing direction, wherein determining the EDT is based at least in part on the correction value.

Aspect 43: The method of aspect 42, wherein determining the correction value comprises determining a local minima value of the function based at least in part on the baseline EDT and the gain delta value, the function comprising a minima function, determining the EDT is based at least in part on the local minima value of the function.

Aspect 44: The method of any of aspects 42 through 43, wherein determining the correction value for the EDT according to the function is based at least in part on at least two angles associated with two or more of the first beam, the second beam, or the third beam.

Aspect 45: The method of any of aspects 35 through 44, wherein determining a correction value for the EDT is based at least in part on a subset of at least two angles.

Aspect 46: The method of any of aspects 35 through 45, wherein determining a correction value associated with the EDT is based at least in part on an index of at least two beam angles corresponding to one or more of the first pointing direction associated with the first beam or the third pointing direction associated with the third beam.

Aspect 47: The method of any of aspects 25 through 46, wherein the first beam comprises a transmitting beam and the second beam comprises a sensing beam.

Aspect 48: An apparatus for wireless communication at a device, comprising a processor; memory coupled with the processor; and instructions stored in the memory and executable by the processor to cause the apparatus to perform a method of any of aspects 1 through 24.

Aspect 49: An apparatus for wireless communication at a device, comprising at least one means for performing a method of any of aspects 1 through 24.

Aspect 50: A non-transitory computer-readable medium storing code for wireless communication at a device, the code comprising instructions executable by a processor to perform a method of any of aspects 1 through 24.

Aspect 51: An apparatus for wireless communication at a device, comprising a processor; memory coupled with the processor; and instructions stored in the memory and executable by the processor to cause the apparatus to perform a method of any of aspects 25 through 47.

Aspect 52: An apparatus for wireless communication at a device, comprising at least one means for performing a method of any of aspects 25 through 47.

Aspect 53: A non-transitory computer-readable medium storing code for wireless communication at a device, the code comprising instructions executable by a processor to perform a method of any of aspects 25 through 47.

It is noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (for example, a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc in which disks usually reproduce data magnetically, while discs reproduce data optically with lasers. Combinations of the above are also included within the scope of computer-readable media.

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (in other words, A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), or ascertaining. Also, “determining” can include receiving (such as receiving information) or accessing (such as accessing data in a memory). Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a device, comprising:
receiving control signaling indicating a beam configuration;
selecting a first beam for wireless communication based at least in part on the beam configuration, the first beam being associated with a first pointing direction;
selecting a second beam based at least in part on the beam configuration, the second beam being associated with a second pointing direction;
determining an energy detection threshold associated with the second beam based at least in part on a first beam gain of the first beam in the first pointing direction and a second beam gain of the second beam in the first pointing direction; and
sensing a channel using the second beam based at least in part on the energy detection threshold associated with the second beam.

2. The method of claim 1, further comprising determining a baseline energy detection threshold based at least in part on the beam configuration, wherein determining the energy detection threshold is based at least in part on the baseline energy detection threshold.

3. The method of claim 2, further comprising determining a gain delta value based at least in part on a difference between the second beam gain of the second beam in the first pointing direction and the first beam gain of the first beam in the first pointing direction, wherein determining the energy detection threshold is based at least in part on one or more of the baseline energy detection threshold or the gain delta value.

4. The method of claim 3, further comprising determining a correction value between a null value and the gain delta value based at least in part on a function, wherein determining the energy detection threshold is based at least in part on the correction value.

5. The method of claim 4, wherein determining the correction value comprises determining a local minima value of the function, the function comprising a minima function, wherein determining the energy detection threshold is based at least in part on the local minima value.

6. The method of claim 4, wherein the function is based at least in part on a first input and a second input, the first input comprising the null value and the second input comprising a second function.

7. The method of claim 6, wherein determining the gain delta value is based at least in part on the second function, the second function comprising a logarithmic function.

8. The method of claim 7, wherein the logarithmic function is based at least in part on a third input and a fourth input, the third input comprising the first beam gain of the first beam in the first pointing direction and the fourth input comprising the second beam gain of the second beam in the first pointing direction.

9. The method of claim 1, further comprising determining that the first beam gain of the first beam in the first pointing direction is greater than the second beam gain of the second beam in the first pointing direction, wherein determining the energy detection threshold is based at least in part on determining that the first beam gain of the first beam in the first pointing direction is greater than the second beam gain of the second beam in the first pointing direction.

10. The method of claim 1, further comprising selecting a third beam for wireless communication based at least in part on the beam configuration, the third beam comprising a third beam gain and being associated with a third pointing direction, the first beam and the third beam associated with a set of beams for wireless communication, wherein determining the energy detection threshold is based at least in part on the first beam in the first pointing direction, the second beam in the first pointing direction, and the third beam in the third pointing direction.

11. The method of claim 10, further comprising determining a baseline energy detection threshold according to a first function and based at least in part on one or more of the first beam in the first pointing direction or the third beam in the third pointing direction, wherein determining the energy detection threshold is based at least in part on the baseline energy detection threshold.

12. The method of claim 11, further comprising determining a local minima value of the first function, the first function comprising a first minima function, the local minima value corresponding to the baseline energy detection threshold, wherein determining the energy detection threshold is based at least in part on the local minima value.

13. The method of claim 11, further comprising determining a gain delta value based at least in part on one or more of a first difference between the second beam gain of the second beam in the first pointing direction and the first beam gain of the first beam in the first pointing direction, or a second difference between the second beam gain of the second beam in the third pointing direction and the third beam gain of the third beam in the third pointing direction, wherein determining the energy detection threshold is based at least in part on one or more of the baseline energy detection threshold or the gain delta value.

14. The method of claim 13, further comprising determining a correction value between a null value and the gain delta value according to a second function, the correction value corresponding to a gain ratio associated with two or more of the first beam gain of the first beam, the second beam gain of the second beam, or the third beam gain of the third beam, wherein determining the energy detection threshold is based at least in part on the correction value.

15. The method of claim 14, wherein determining the correction value comprises determining a local minima value of the second function, the second function comprising a second minima function, wherein determining the energy detection threshold is based at least in part on the local minima value.

16. The method of claim 14, wherein determining the correction value for the energy detection threshold according to one or more of the first function or the second function is based at least in part on a single beam angle associated with at least one of the first beam, the second beam, or the third beam.

17. The method of claim 10, further comprising determining a correction value between a baseline energy detection threshold and a gain delta value based at least in part on a function, the baseline energy detection threshold is based at least in part on one or more of the first beam, the second beam, or the third beam, the gain delta value is based at least in part on one or more of a first difference between the second beam gain of the second beam in the first pointing direction and the first beam gain of the first beam in the first pointing direction, or a second difference between the second beam gain of the second beam in the third pointing direction and the third beam gain of the third beam in the third pointing direction, wherein determining the energy detection threshold is based at least in part on the correction value.

18. The method of claim 17, wherein determining the correction value comprises determining a local minima value of the function based at least in part on the baseline energy detection threshold and the gain delta value, the function comprising a minima function, wherein determining the energy detection threshold is based at least in part on the local minima value.

19. The method of claim 17, wherein determining the correction value for the energy detection threshold according to the function is based at least in part on a single beam angle associated with at least one of the first beam, the second beam, or the third beam.

20. A method for wireless communication at a device, comprising:
receiving control signaling indicating a beam configuration;
selecting a first beam for wireless communication based at least in part on the beam configuration, the first beam being associated with a first pointing direction;
selecting a second beam based at least in part on the beam configuration, the second beam being associated with a second pointing direction;
determining an energy detection threshold associated with the second beam based at least in part on a second beam gain of the second beam in the second pointing direction and a first beam gain of the first beam in the first pointing direction; and
sensing a channel using the second beam based at least in part on the energy detection threshold associated with the second beam.

21. The method of claim 20, further comprising determining that the first pointing direction associated with the first beam and the second pointing direction associated with the second beam satisfy a threshold, wherein determining the energy detection threshold is based at least in part on determining that the first pointing direction associated with the first beam and the second pointing direction associated with the second beam satisfy the threshold.

22. The method of claim 20, further comprising determining a baseline energy detection threshold based at least in part on the beam configuration, wherein determining the energy detection threshold is based at least in part on the baseline energy detection threshold.

23. The method of claim 22, further comprising determining a gain delta value based at least in part on a difference between the second beam gain of the second beam in the second pointing direction and the first beam gain of the first beam in the first pointing direction, wherein determining the energy detection threshold is based at least in part on one or more of the baseline energy detection threshold or the gain delta value.

24. The method of claim 23, further comprising determining a correction value between a null value and the gain delta value based at least in part on a function, wherein determining the energy detection threshold is based at least in part on the correction value.

25. An apparatus for wireless communication at a device, comprising:
a processor;
memory coupled with the processor; and
instructions stored in the memory and executable by the processor to cause the apparatus to:
receive control signaling indicating a beam configuration;
select a first beam for wireless communication based at least in part on the beam configuration, the first beam being associated with a first pointing direction;
select a second beam based at least in part on the beam configuration, the second beam being associated with a second pointing direction;
determine an energy detection threshold associated with the second beam based at least in part on a first beam gain of the first beam in the first pointing direction and a second beam gain of the second beam in the first pointing direction; and
sense a channel using the second beam based at least in part on the energy detection threshold associated with the second beam.

26. The apparatus of claim 25, wherein the instructions are further executable by the processor to cause the apparatus to determine a baseline energy detection threshold based at least in part on the beam configuration, wherein the instructions to determine the energy detection threshold are further executable by the processor based at least in part on the baseline energy detection threshold.

27. The apparatus of claim 26, wherein the instructions are further executable by the processor to cause the apparatus to determine a gain delta value based at least in part on a difference between the second beam gain of the second beam in the first pointing direction and the first beam gain of the first beam in the first pointing direction, wherein the instructions to determine the energy detection threshold are further executable by the processor based at least in part on one or more of the baseline energy detection threshold or the gain delta value.

28. An apparatus for wireless communication at a device, comprising:
a processor;
memory coupled with the processor; and
instructions stored in the memory and executable by the processor to cause the apparatus to:
receive control signaling indicating a beam configuration;
select a first beam for wireless communication based at least in part on the beam configuration, the first beam being associated with a first pointing direction;
select a second beam based at least in part on the beam configuration, the second beam being associated with a second pointing direction;
determine an energy detection threshold associated with the second beam based at least in part on a second beam gain of the second beam in the second pointing direction and a first beam gain of the first beam in the first pointing direction; and
sense a channel using the second beam based at least in part on the energy detection threshold associated with the second beam.

29. The apparatus of claim 28, wherein the instructions are further executable by the processor to cause the apparatus to determine that the first pointing direction associated with the first beam and the second pointing direction associated with the second beam satisfy a threshold, wherein the instructions to determine the energy detection threshold are further executable by the processor based at least in part on determining that the first pointing direction associated with the first beam and the second pointing direction associated with the second beam satisfy the threshold.

30. The apparatus of claim 28, wherein the instructions are further executable by the processor to cause the apparatus to determine a baseline energy detection threshold based at least in part on the beam configuration, wherein the instructions to determine the energy detection threshold are further executable by the processor based at least in part on the baseline energy detection threshold.
